(19) United States
(12) Patent Application Publication
(10) Pub. No.: US 2026/0303383 A1
(43) Pub. Date: Oct. 1, 2026

(54) SECURE DATA FINGERPRINTING AND IMMUTABLE DATA STORAGE USING AN APPLICATION-SPECIFIC DISTRIBUTED LEDGER

(71) Applicant: Constellation Network, Inc., Beverly Hills, CA (US)

(72) Inventors: Benjamin Jorgensen, Calistoga, CA (US); Benjamin Diggles, Denver, CO (US); David Berg, Elmhurst, IL (US); Alexander Brandes, Portland, OR (US); Ryle Goehausen, Los Gatos, CA (US); James Aman, Austin, TX (US); Douglas Muskat, Boynton Beach, FL (US)

(21) Appl. No.: 19/578,283

(22) Filed: Mar. 25, 2026

Related U.S. Application Data
(60) Provisional application No. 63/868,671, filed on Aug. 22, 2025.
(60) Provisional application No. 63/777,361, filed on Mar. 25, 2025.

(51) Int. Cl. H04L 9/00; G06F 16/22; G06F 16/28

(52) U.S. Cl. CPC H04L 9/50; G06F 16/2246; G06F 16/2255; G06F 16/289

(57) ABSTRACT

Embodiments of the present disclosure provide for providing secure data fingerprinting and immutable data storage using an application-specific distributed ledger. Some examples provide for receiving an application programming interface (API) data structure that comprises a digital fingerprint for digital data associated with a client device event, aggregating the digital fingerprint with one or more other digital fingerprints to generate an aggregated digital fingerprint data structure, generating a hash data structure based on the aggregated digital fingerprint data structure, adding the hash data structure to an application-specific distributed ledger based on a validation rule set that defines a domain-specific data schema for the application-specific distributed ledger, storing the aggregated digital fingerprint data structure in an object-relational database, and generating an output associated with the digital fingerprint based on the hash data structure and the aggregated digital fingerprint data structure.

### CROSS REFERENCE TO RELATED APPLICATIONS

This application claims priority to U.S. Appl. No. 63/777,361 filed Mar. 25, 2025 and U.S. Appl. No. 63/868,671 filed Aug. 22, 2025, the contents of which are incorporated herein in their entirety by reference.

### TECHNOLOGICAL FIELD

Embodiments of the present disclosure generally relate to distributed ledger systems, and more particularly to a distributed ledger platform utilizing data fingerprinting and cryptography to aggregate and store digital data on a distributed ledger.

### BACKGROUND

Applicant has identified many deficiencies and problems associated with existing methods, apparatus, and systems related to storage and retrieval of data from disparate data sources. Through applied effort, ingenuity, and innovation, many of these identified deficiencies and problems have been solved by developing solutions that are configured in accordance with embodiments of the present disclosure, many examples of which are described in detail herein.

### BRIEF SUMMARY

Various embodiments of the present disclosure are directed to improved apparatuses, systems, and methods for providing secure data fingerprinting and immutable data storage using an application-specific distributed ledger.

In an embodiment, an apparatus comprises one or more processors and one or more storage devices storing instructions that are operable, when executed by the one or more processors, to cause the one or more processors to receive an application programming interface (API) data structure that comprises a digital fingerprint for digital data associated with a client device event. In one or more embodiments, the instructions are additionally or alternatively operable, when executed by the one or more processors, to cause the one or more processors to aggregate the digital fingerprint with one or more other digital fingerprints to generate an aggregated digital fingerprint data structure that maps the digital fingerprint and the one or more other digital fingerprints via a hierarchical tree structure. In one or more embodiments, the instructions are additionally or alternatively operable, when executed by the one or more processors, to cause the one or more processors to generate a hash data structure based at least in part on the aggregated digital fingerprint data structure. In one or more embodiments, the instructions are additionally or alternatively operable, when executed by the one or more processors, to cause the one or more processors to add the hash data structure to an application-specific distributed ledger based at least in part on a validation rule set that defines a domain-specific data schema for the application-specific distributed ledger. In one or more embodiments, the instructions are additionally or alternatively operable, when executed by the one or more processors, to cause the one or more processors to store the aggregated digital fingerprint data structure in an object-relational database. In one or more embodiments, the instructions are additionally or alternatively operable, when executed by the one or more processors, to cause the one or more processors to generate an output associated with the digital fingerprint based at least in part on (i) the hash data structure added to the application-specific distributed ledger and (ii) the aggregated digital fingerprint data structure stored in the object-relational database.

In another embodiment, a computer-implemented method comprises receiving an API data structure that comprises a digital fingerprint for digital data associated with a client device event. In one or more embodiments, the computer-implemented method additionally or alternatively comprises aggregating the digital fingerprint with one or more other digital fingerprints to generate an aggregated digital fingerprint data structure that maps the digital fingerprint and the one or more other digital fingerprints via a hierarchical tree structure. In one or more embodiments, the computer-implemented method additionally or alternatively comprises generating a hash data structure based at least in part on the aggregated digital fingerprint data structure. In one or more embodiments, the computer-implemented method additionally or alternatively comprises adding the hash data structure to an application-specific distributed ledger based at least in part on a validation rule set that defines a domain-specific data schema for the application-specific distributed ledger. In one or more embodiments, the computer-implemented method additionally or alternatively comprises storing the aggregated digital fingerprint data structure in an object-relational database. In one or more embodiments, the computer-implemented method additionally or alternatively comprises generating an output associated with the digital fingerprint based at least in part on (i) the hash data structure added to the application-specific distributed ledger and (ii) the aggregated digital fingerprint data structure stored in the object-relational database.

In yet another embodiment, a computer program product comprises at least one non-transitory computer-readable storage medium having computer-readable program code portions stored therein, where the computer-readable program code portions comprising the executable portion are configured to receive an API data structure that comprises a digital fingerprint for digital data associated with a client device event. In one or more embodiments, the computer-readable program code portions comprising the executable portion are additionally or alternatively configured to aggregate the digital fingerprint with one or more other digital fingerprints to generate an aggregated digital fingerprint data structure that maps the digital fingerprint and the one or more other digital fingerprints via a hierarchical tree structure. In one or more embodiments, the computer-readable program code portions comprising the executable portion are additionally or alternatively configured to generate a hash data structure based at least in part on the aggregated digital fingerprint data structure. In one or more embodiments, the computer-readable program code portions comprising the executable portion are additionally or alternatively configured to add the hash data structure to an application-specific distributed ledger based at least in part on a validation rule set that defines a domain-specific data schema for the application-specific distributed ledger. In one or more embodiments, the computer-readable program code portions comprising the executable portion are additionally or alternatively configured to store the aggregated digital fingerprint data structure in an object-relational database. In one or more embodiments, the computer-readable program code portions comprising the executable portion are additionally or alternatively configured to generate an output associated with the digital fingerprint based at least in part on (i) the hash data structure added to the application-specific distributed ledger and (ii) the aggregated digital fingerprint data structure stored in the object-relational database.

The above summary is provided merely for purposes of summarizing some example embodiments to provide a basic understanding of some aspects of the present disclosure. Accordingly, it will be appreciated that the above-described embodiments are merely examples and should not be construed to narrow the scope or the spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings. Some embodiments may include the components arranged in a different way:

FIG. 1 illustrates a block diagram of a system that can be specially configured within which at least one example embodiment of the present disclosure may operate;

FIG. 2 illustrates a block diagram of an example apparatus that can be specially configured in accordance with at least one example embodiment of the present disclosure;

FIG. 3 illustrates an example data flow system as part of a process for providing secure data fingerprinting and immutable data storage in accordance with at least one example embodiment of the present disclosure;

FIG. 4 illustrates a system depicting a data flow architecture for secure data fingerprinting and immutable storage from disparate data sources in accordance with at least one example embodiment of the present disclosure;

FIG. 5 illustrates an example data flow architecture for a digital evidence system in accordance with at least one example embodiment of the present disclosure;

FIG. 6 illustrates another example data flow architecture for a digital evidence system in accordance with at least one example embodiment of the present disclosure;

FIG. 7 illustrates an example electronic interface response in accordance with at least one example embodiment of the present disclosure;

FIG. 8 illustrates another example electronic interface response in accordance with at least one example embodiment of the present disclosure;

FIG. 9 illustrates another example electronic interface response in accordance with at least one example embodiment of the present disclosure;

FIG. 10 illustrates another example electronic interface response in accordance with at least one example embodiment of the present disclosure;

FIG. 11 illustrates an example data flow system as part of a process for providing secure for secure data fingerprinting and immutable storage of AI decision data in accordance with at least one example embodiment of the present disclosure;

FIG. 12 illustrates a process depicting example operations for providing secure data fingerprinting and immutable data storage using an application-specific distributed ledger in accordance with at least one embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure can be embodied in many different forms and should not be construed as limited to the embodiments set forth herein, rather, these embodiments are provided so that this disclosure will satisfy applicable legal requirements. Like numbers refer to like elements throughout.

### Overview

Storage of data from disparate data sources presents significant technical challenges to establish verifiable records of data provenance and/or data authenticity. For instance, centralized databases for data storage and verification lack the immutability and trust guarantees that distributed ledger technology provides. Data stored in centralized systems remains subject to modification and the integrity of historical records depends entirely on the trustworthiness and security practices of the operating entity. This limitation proves particularly problematic for use cases requiring verifiable audit trails, regulatory compliance documentation, or evidence preservation where the ability to demonstrate that data has not been altered is desirable. Further, operating a distributed ledger infrastructure with various distributed nodes and consensus mechanisms is typically technologically complex and involves significant computing resources.

Moreover, when a single entity or a consortium of related entities controls an entire distributed ledger ecosystem (e.g., the nodes that participate in consensus, the underlying code, and the network infrastructure) the controlling entity retains the ability to modify the system in ways that could alter historical records or change the rules governing data validation. In such configurations, the distributed ledger effectively functions as a database with additional complexity rather than as a system providing meaningful trust guarantees through decentralization. As such, the ability to establish trust without relying on a central authority may be diminished with less desirable distributed ledger infrastructures. For other distributed ledger infrastructures configured as a public distributed ledger network that distributes consensus across a decentralized network of independent nodes, the public distributed ledger protocols and the participation of numerous unaffiliated validators creates a system where no single entity can unilaterally modify historical records or change the rules of operation.

Additionally, less desirable distributed ledger architectures often impose limitations on data throughput and storage capacity that constrain their applicability to high-volume use cases. Storing complete data payloads directly on-chain can result in excessive storage costs, reduced transaction throughput, and potential exposure of sensitive information on a distributed ledger. The lack of standardized integration patterns further complicates the adoption of distributed ledger technology for data verification purposes. Systems with existing data pipelines and workflow systems also face technical challenges for bridging the gap between application programming interfaces and the specialized protocols utilized for distributed ledger interaction. These technical complexities often result in development efforts that are difficult to maintain and scale for a distributed ledger architecture.

To account for these and/or other technical challenges related to less desirable techniques for storing and/or retrieving data from disparate data sources, embodiments of the present disclosure provide secure data fingerprinting and immutable data storage using an application-specific distributed ledger. For instance, the trust and immutability benefits of a public distributed ledger may be combined with the accessibility of an API to provide an improved distributed ledger platform for storing and/or retrieving data from disparate data sources.

In some embodiments, digital fingerprints are received from client devices through a centralized API layer that abstracts the complexity of blockchain. Additionally, multiple digital fingerprints may be aggregated into hierarchical tree structures that enable efficient on-chain storage while maintaining complete fingerprint data in an object-relational database for retrieval and querying purposes. The aggregation approach enables processing of higher volumes of fingerprint submissions while minimizing the data stored on the distributed ledger, addressing scalability constraints for less desirable distributed ledger architectures. Fingerprint submissions may also be validated against domain-specific data schemas defined by the application-specific distributed ledger. Additionally, validated data may be transmitted to a consensus layer that provides global consensus and cross-network coordination.

In some embodiments, dashboard visualizations and search capabilities that enable users to view, search, and/or verify fingerprint records through an electronic interface may be provided. Document storage alongside fingerprint submissions may also be provided to enable users to maintain complete audit trails of both cryptographic proofs and source materials. In some embodiments, the distributed ledger platform disclosed herein may support domain-specific applications including asset documentation (e.g., real estate property documentation, etc.), artificial intelligence (AI) decision logging, and/or autonomous agent workflows.

By employing the distributed ledger platform disclosed herein to manage data fingerprinting and immutable storage workflows, computing resources and memory allocation with respect to processing and storage of data verification records can be improved through efficient aggregation and selective on-chain storage. In doing so, various embodiments of the present disclosure make substantial technical contributions to improving the efficiency and effectiveness of distributed ledger systems for data integrity verification. Various embodiments of the present disclosure additionally provide improved data provenance tracking, improved audit trail generation, improved regulatory compliance documentation, improved evidence preservation, and/or improved integration with existing enterprise systems and workflows through API interfaces. Moreover, various embodiments of the present disclosure additionally provide improved scalability through hierarchical fingerprint aggregation, improved availability through hybrid centralized and decentralized architecture, and/or improved trust guarantees through anchoring to public distributed ledger networks with decentralized consensus.

In some embodiments, a digital evidence apparatus for the distributed ledger platform receives an API message that comprises a digital fingerprint for data associated with a client device. The digital fingerprint may comprise a cryptographic hash of the data and metadata such as a timestamp and/or an entity identifier. Rather than storing the complete data payload on-chain, which would limit scalability and potentially expose sensitive information, the system stores only the digital fingerprint, enabling verification of data integrity while maintaining efficiency and privacy.

To address scalability requirements, the digital evidence apparatus may aggregate the digital fingerprint with one or more other digital fingerprints to generate an aggregated digital fingerprint data structure that maps the digital fingerprint and the one or more other digital fingerprints via a hierarchical tree structure. In some embodiments, the hierarchical tree structure comprises a Merkle tree (e.g., a Patricia Merkle tree) that maps multiple digital fingerprints to a single cryptographic hash. This aggregation approach enables the distributed ledger platform to process larger volumes of fingerprint submissions while minimizing the data stored on the distributed ledger. For example, thousands of individual digital fingerprints may be represented by a single hash data structure on-chain, with the complete fingerprint data maintained in an object-relational database for retrieval and querying purposes.

The digital evidence apparatus may also generate a hash data structure based at least in part on the aggregated digital fingerprint data structure and adds the hash data structure to an application-specific distributed ledger based at least in part on a validation rule set that defines a domain-specific data schema for the application-specific distributed ledger. The application-specific distributed ledger operates as a custom blockchain that defines its own consensus rules, data models, and/or validation logic while connecting to a broader network for global consensus. In some embodiments, based at least in part on the hash data structure being added to the application-specific distributed ledger, the at least a portion of the hash data structure is transmitted to a consensus layer that connects the application-specific distributed ledger to one or more other distributed ledgers. For instance, the consensus layer may serve as a global consensus layer that finalizes data for inclusion in global snapshots, providing immutability and cross-network coordination.

The distributed ledger platform of the present disclosure combines centralized components with decentralized components to provide both ease of integration and strong trust guarantees. The distributed ledger platform may also utilize an API endpoint that receives API messages from client devices, batch processing components that aggregate digital fingerprints, and an object-relational database that stores the aggregated digital fingerprint data structure for subsequent retrieval. The decentralized components may include the application-specific distributed ledger and the consensus layer to provide validation, consensus, and immutable storage. This hybrid architecture also enables the distributed ledger platform to maintain high data throughput even during temporary outages of the distributed ledger components, as a centralized layer of the distributed ledger platform may queue incoming fingerprints until the decentralized components become available.

In some embodiments, the digital evidence apparatus stores the aggregated digital fingerprint data structure in an object-relational database and causes a rendering of a dashboard visualization associated with the digital fingerprint via an electronic interface based at least in part on the hash data structure added to the application-specific distributed ledger and the aggregated digital fingerprint data structure stored in the object-relational database. The dashboard visualization may provide an interface where users may view recent fingerprint submissions and/or access detailed information about individual fingerprints. In some embodiments, the distributed ledger platform receives a search query via a search API, retrieves the digital fingerprint from the object-relational database based at least in part on the search query, and causes the rendering of the dashboard visualization based at least in part on the search query.

The distributed ledger platform also supports document storage alongside fingerprint submissions. For instance, the digital evidence apparatus may receive a document data structure associated with the digital fingerprint, verify that a first hash of the document data structure matches a second hash of the digital fingerprint, correlate the document data structure with the aggregated digital fingerprint data structure stored in the object-relational database, and cause the rendering of the dashboard visualization based at least in part on the hash data structure added to the application-specific distributed ledger, the aggregated digital fingerprint data structure stored in the object-relational database, and the document data structure. This capability enables users to store original documents, such as images or files, alongside their cryptographic fingerprints to provide a complete audit trail of both the proof and the source material.

It is to be appreciated that the digital fingerprint structure may include multiple data fields that enable identification, verification, and retrieval. For instance, each digital fingerprint may include an organization identifier, a tenant identifier, an event identifier that uniquely identifies the particular fingerprint submission, a document identifier that references a document in the client's system, a document reference comprising the cryptographic hash of the document content, a timestamp, a version number, a signer identifier comprising a public key, and/or one or more other data fields. The client device may sign the fingerprint payload with a private key and provides the signature along with the public key, enabling verification that the client was the entity that signed and certified the data.

Various embodiments of the present disclosure also support domain-specific applications built on top of the digital evidence platform. In some embodiments, the data associated with the digital fingerprint comprises real estate property data associated with one or more real estate asset events, and the dashboard visualization comprises a property history interface that displays a chronological record of digital fingerprints associated with the real estate property data. In some embodiments, the digital evidence apparatus may receive a first digital fingerprint for a first image associated with a real estate asset and a second digital fingerprint for a second image associated with the real estate asset, aggregate the first digital fingerprint and the second digital fingerprint to generate the aggregated digital fingerprint data structure, and generate the hash data structure based at least in part on the aggregated digital fingerprint data structure. In some embodiments, a real estate audit report may be generated for the real estate asset based at least in part on the aggregated digital fingerprint data structure stored in the object-relational database and cause a rendering of the real estate audit report via the dashboard visualization. It is also to be appreciated that the domain-specific applications may be utilized for one or more other types of assets besides a real estate property asset.

With a real estate application for the distributed ledger platform, property owners may maintain a complete history of their property including build materials, inspection photographs, permits, warranties, receipts, and/or maintenance records. This documentation chain provides value for multiple use cases including insurance underwriting, property sales, rental management, and compliance verification. For example, a builder developing new construction can document the entire build process from foundation to completion, creating a verifiable record that transfers with the property to subsequent owners.

Additional applications of the digital evidence platform include artificial intelligence decision logging for regulatory compliance. As regulations increasingly require documentation of algorithmic decision-making, particularly for decisions affecting credit worthiness, healthcare, or other significant outcomes, the system provides an immutable record of the inputs and logic used in automated decisions. Because the data is stored on a public distributed ledger, the records cannot be retroactively modified, addressing concerns with respect to artificial intelligent (AI) systems rewriting their own logs.

The system architecture also supports integration with AI agents through a Model Context Protocol (MCP) server that enables AI tools to interact directly with the digital evidence platform. For instance, AI agents may validate documents, verify fingerprints, search records, and/or generate audit reports through natural language interactions. The distributed ledger platform also supports payment negotiation protocols that allow AI agents to negotiate costs and submit payments directly, enabling autonomous agent workflows without pre-established service accounts.

Various embodiments of the present disclosure provide technical improvements for distributed ledgers including, but not limited to, improved scalability through digital fingerprint batching that enables a vast amount of digital fingerprints to be represented by a single root hash stored on-chain, improved data availability through a hybrid centralized and decentralized architecture where incoming data may be queued during temporary unavailability of the distributed ledger components, improved integration with external systems through an API that reduces distributed ledger communication complexity and enables adoption of the distributed ledger with existing data pipelines and workflow systems, improved efficiency for the distributed ledger platform by storing digital fingerprints on-chain rather than complete data payloads, improved trust guarantees for data through anchoring to a distributed ledger network with decentralized consensus where no single entity can unilaterally modify historical records, and/or improved data verification capabilities through validation proofs that enable verification of individual digital fingerprints against the root hash stored on an application-specific distributed ledger.

Various embodiments of the present disclosure also provide technical improvements to less desirable distributed ledger technology by utilizing a hierarchical tree structure to aggregate multiple digital fingerprints into a single hash data structure, thereby reducing on-chain storage requirements and improving transaction throughput compared to less desirable distributed ledger architectures that store complete data payloads directly on-chain. Additionally, a hybrid architecture of various embodiments of the present disclosure may combine centralized components (e.g., an API endpoint, batch processing, and/or an object-relational database) with decentralized components (e.g., an application-specific distributed ledger and a consensus layer) to enable improved data throughput to a distributed ledger and/or reduce computing resources for a network associated with the distributed ledger. A validation rule set that defines a domain-specific data schema for the application-specific distributed ledger may also provide enable properly formatted and authorized data to be accepted for immutable storage via the distributed ledger.

### Example Terminology

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, sensor devices, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

In some embodiments, the terms “client device,” “computing device,” “user device,” and the like may be used interchangeably to refer to computer hardware configured (either physically or by the execution of software) to access one or more applications, services, or repositories made available by a server. Among various other functions, these computing devices are configured to directly or indirectly transmit and receive data via a network. The server is often (but not always) on another computer system, in which case the client device accesses the service by way of a communication network.

Example client devices include, without limitation, smartphones (e.g., Apple iPhone, Samsung Galaxy, Google Pixel), tablet computers (e.g., Apple iPad, Microsoft Surface, etc.), laptop computers (e.g., Apple MacBook, Dell XPS, Lenovo ThinkPad, etc.), wearable devices (e.g., smartwatches such as Apple Watch and Samsung Galaxy Watch, eyewear such as Google Glass and Meta Ray-Ban, helmets, hats, other wearable devices, clothing, earpieces with wireless connectivity such as Apple AirPods and Samsung Galaxy Buds, and the like), personal computers, desktop computers (e.g., Apple iMac, Dell OptiPlex, HP Pavilion), enterprise computers, workstations, and any other computing devices known to one skilled in the art in light of the present disclosure. Each client device may be associated with one or more user profiles and may implement authentication mechanisms to verify user identity

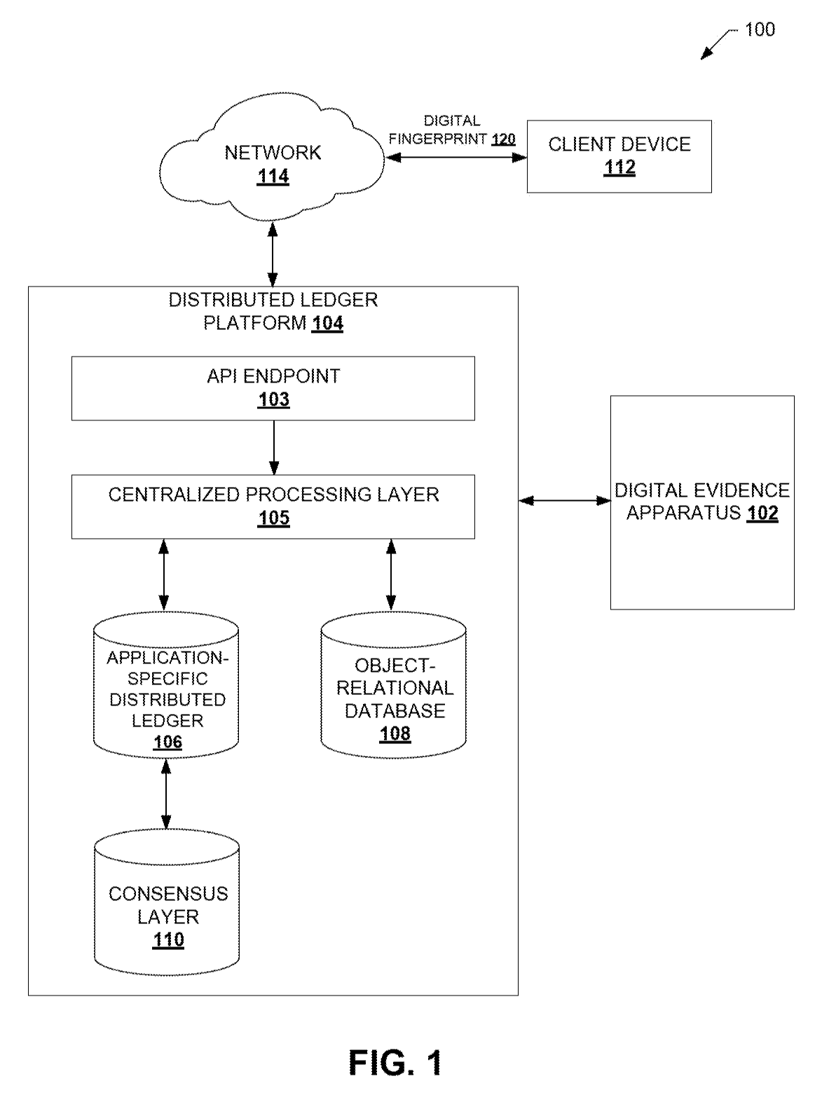

The term “server computing device” refers to a combination of computer hardware and/or software that is configured to provide a component to a client device. An example of a server computing device is the distributed ledger platform of FIG. 1. Another example of a server computing device is, in certain embodiments, the digital evidence apparatus 102 of FIG. 1. In some embodiments, a server computing device communicates with one or more client computing devices using one or more computer networks.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The term “API data structure” refers to a structured data format transmitted through an API for communication between computing systems. An API data structure encapsulates information in a defined format that enables interoperability between client devices and server-side components. In the context of the distributed ledger platform, an API data structure may comprise a digital fingerprint along with associated metadata, identifiers, and/or cryptographic signatures that together form a complete submission payload. The API data structure may be formatted according to RESTful conventions, enabling transmission over standard network protocols such as HTTP. When an API data structure is received at an API endpoint of the distributed ledger platform, the centralized processing layer parses the structured data to extract the digital fingerprint and associated fields for subsequent aggregation, validation, and storage operations. In some embodiments, an API data structure is an API message, an API call, or another type of API communication.

The term “digital fingerprint” refers to a cryptographic representation of data that uniquely identifies the content and enables verification of data integrity. A digital fingerprint comprises a cryptographic hash of the data content along with associated metadata and identifiers that together provide a compact, tamper-evident representation of the original data. In some embodiments, the digital fingerprint includes an organization identifier, a tenant identifier, an event identifier that uniquely identifies the particular fingerprint submission, a document identifier that references a document in the client's system, a document reference comprising the cryptographic hash of the document content, a timestamp, a version number, and/or a signer identifier comprising a public key. Rather than storing complete data payloads on-chain, the distributed ledger platform stores digital fingerprints to enable verification of data integrity while maintaining efficiency and privacy. A client device may sign the digital fingerprint payload with a private key and provide the signature along with the public key, enabling verification that the client was the entity that signed and certified the data. Digital fingerprints are received through the API endpoint and processed by the centralized processing layer for aggregation into hierarchical tree structures before being committed to an application-specific distributed ledger.

The term “digital data” refers to information in electronic form that is associated with a client device and subject to fingerprinting for immutable storage and verification. Digital data encompasses any content that can be represented in binary format and processed by computing systems, including documents, images, sensor data, transaction records, AI decision data, and/or other electronic information. The digital data serves as the source material from which a digital fingerprint is generated through cryptographic hashing operations. In some embodiments, the digital data comprises real estate property data associated with one or more real estate asset events, such as inspection photographs, permits, warranties, receipts, and maintenance records. In other embodiments, the digital data comprises artificial intelligence decision data associated with inputs utilized by an AI model to generate AI model output. The digital data itself may be retained by the client device or stored in a separate document storage system, while the digital fingerprint derived from the digital data is submitted to the distributed ledger platform for immutable storage. This approach enables verification of data integrity without requiring the complete data payload to be stored on the distributed ledger.

The term “client device event” refers to an occurrence or action associated with a client device that triggers the generation and submission of a digital fingerprint to the distributed ledger platform. In some embodiments, a client device event corresponds to a data capture event for digital data. For instance, a client device event may represent a discrete happening that produces data requiring cryptographic verification and immutable storage, such as the creation of a document, the capture of an image, the recording of a sensor measurement, or the execution of an automated decision. Each client device event may be associated with a unique event identifier that distinguishes the event from other events within the system. When a client device event occurs, a client device may generate a digital fingerprint for the data associated with the event and transmits an API data structure containing the digital fingerprint to the API endpoint of the distributed ledger platform.

The term “aggregated digital fingerprint data structure” refers to a data structure that combines multiple digital fingerprints into a unified representation using a hierarchical tree structure. In some embodiments, the aggregated digital fingerprint data structure maps individual digital fingerprints received over a period of time into a tree-based organization that enables efficient cryptographic verification while maintaining references to each constituent fingerprint. In some embodiments, the hierarchical tree structure comprises a Merkle tree, such as a Patricia Merkle tree or another type of Merkle tree structure, that maps multiple digital fingerprints to a single cryptographic hash. This aggregation approach enables the distributed ledger platform to process larger volumes of fingerprint submissions while minimizing the data stored on the distributed ledger. For example, thousands of individual digital fingerprints may be represented by a single hash data structure on-chain, with the complete fingerprint data maintained in the aggregated digital fingerprint data structure stored in an object-relational database for retrieval and querying purposes. The aggregated digital fingerprint data structure preserves the ability to verify individual digital fingerprints through validation proofs that demonstrate inclusion within the hierarchical tree structure.

The term “hierarchical tree structure” refers to a tree-based data organization that arranges digital fingerprints in a parent-child relationship enabling efficient cryptographic aggregation and verification. A hierarchical tree structure organizes data elements as nodes connected by edges, where each node except the root has exactly one parent node and may have zero or more child nodes. In the context of the distributed ledger platform, the hierarchical tree structure may comprise a Merkle tree that maps multiple digital fingerprints to a single cryptographic hash through recursive hashing of node pairs from leaf nodes to the root. In some embodiments, the Merkle tree is a Patricia Merkle tree (e.g., a Merkle-Patricia tree) that provides additional efficiency for storing attestations of large amounts of data with a compact root hash. For example, data for a Merkle-Patricia trie may utilize a key-value store to enable lookup of a value by key where the key is knowable by the client when submitting a digital fingerprint to an API. This may provide an improved indexing mechanism since the key derivation is non-interactive and deterministic, enabling clients to derive lookup keys at submission time without utilizing interaction with the system during batch construction. The hierarchical tree structure enables verification of individual digital fingerprints against the root hash through validation proofs that include the sibling hashes along the path from the leaf node to the root. This structure addresses scalability constraints by enabling the distributed ledger platform to represent numerous individual digital fingerprints with a single hash data structure stored on-chain.

The term “hash data structure” refers to a cryptographic data structure generated from the aggregated digital fingerprint data structure that is stored on the application-specific distributed ledger. The hash data structure may comprise the root hash of the hierarchical tree structure along with any associated metadata required for validation and retrieval operations. The hash data structure represents a compact cryptographic commitment to all digital fingerprints contained within the aggregated digital fingerprint data structure, enabling verification of data integrity without storing the complete fingerprint data on-chain. When the hash data structure is added to the application-specific distributed ledger, the hash data structure may undergo validation against a validation rule set that defines a domain-specific data schema for the application-specific distributed ledger. Once validated and included in a metagraph snapshot, the hash data structure may be transmitted to the consensus layer for global consensus and permanent on-chain storage. As such, the hash data structure serves as the immutable anchor point against which individual digital fingerprints can be verified through validation proofs.

The term “application-specific distributed ledger” refers to a specially-configured distributed ledger (e.g., a custom blockchain) that defines its own consensus rules, data models, and/or validation logic while connecting to a broader network for global consensus. For instance, an application-specific distributed ledger may comprise a decentralized database architecture that maintains an expandable list of records (e.g., blocks) that may be linked and secured using cryptographic techniques across multiple nodes in a network. An application-specific distributed ledger may operate as an independent subnet with its own state, logic, and/or validation rules while anchoring final results to a consensus layer that serves as a global consensus layer. The application-specific distributed ledger may validate incoming data against a validation rule set that defines a domain-specific data schema, ensuring that properly formatted and authorized data is accepted for storage. In some embodiments, the application-specific distributed ledger includes multiple layer components including a currency layer for token transactions and a data layer for domain-specific custom data updates. The application-specific distributed ledger may also package validated data into metagraph snapshots, which represent a finalized state of the application-specific distributed ledger. These snapshots are submitted to the consensus layer for inclusion in global snapshots, at which point the data is considered finalized and recorded on-chain with immutability guarantees. The application-specific distributed ledger enables the distributed ledger platform to maintain application-specific validation logic while benefiting from the security and decentralization of the broader network. In some embodiments, the application-specific distributed ledger is a metagraph (e.g., a metagraph distributed ledeger) that that operates as a modular, application-specific component of a distributed network. For exmaple, the metagraph may be composed of a Layer 0 (L0) component and one or more Layer 1 (L1) components that together manage the ingestion, validation, consensus, and/or finalization of data. In some embodiments, the L1 components may be responsible for ingesting data, performing initial validation, and/or reaching a consensus. Additionally, the L0 component may perform final validation, run majority-based consensus, and/or package validated blocks from the L1 components into metagraph snapshots. Additionally, the application-specific distributed ledger may be utilized to anchor digital fingerprints to a public network with decentralized consensus where no single entity can unilaterally modify historical records, thereby providing immutability guarantees and trust without relying on a central authority. Additionally, an aggregated digital fingerprint data structure provided to the application-specific distributed ledger may be represented by a single hash data structure stored on-chain, thereby improving scalability constraints of less desirable distributed ledger architectures while maintaining the ability to verify individual fingerprints through validation proofs that demonstrate inclusion within the aggregated digital fingerprint data structure.

The term “validation rule set” refers to a collection of rules that define a domain-specific data schema and validation logic for the application-specific distributed ledger. The validation rule set specifies the structure, format, and constraints that incoming data must satisfy to be accepted for storage on the application-specific distributed ledger. The validation rule set may include rules for verifying cryptographic signatures, checking data format compliance, validating timestamp ordering, confirming authorization of submitting entities, and/pr enforcing domain-specific logic. When a hash data structure is submitted to the application-specific distributed ledger, the validation rule set is applied to determine whether the data conforms to the schema and satisfies all validation criteria. Data that fails validation is rejected and not included in metagraph snapshots. The validation rule set enables the application-specific distributed ledger to enforce application-specific requirements while maintaining the integrity and consistency of the stored data. By defining domain-specific validation logic, the validation rule set supports diverse use cases including real estate property documentation, artificial intelligence decision logging, and other applications requiring verifiable data storage.

The term “object-relational database” refers to a database system that stores the aggregated digital fingerprint data structure and associated data for retrieval and querying purposes. An object-relational database combines features of relational databases with object-oriented database concepts, enabling storage of complex data structures while supporting structured query operations. In some embodiments, the object-relational database comprises a Postgres database that maintains the complete fingerprint data including all metadata fields, signatures, and references to associated documents. The object-relational database stores data using a schema that includes a primary key structure comprising block ordinal, timestamp, and hash, along with fields for signature and block identifiers, primary fields, and document values stored in JSON format. The object-relational database enables search functionality and dashboard visualization rendering based on the stored fingerprint data. In some embodiments, the object-relational database includes read replica components that handle read operations separately from write operations to improve system performance and availability. The object-relational database may be utilized in conjunction with the application-specific distributed ledger, where the hash data structure provides immutable verification while the object-relational database provides efficient retrieval and querying of complete fingerprint data.

The term “output” refers to information generated by the distributed ledger platform based on the hash data structure added to the application-specific distributed ledger and the aggregated digital fingerprint data structure stored in the object-relational database. The output may take various forms depending on the application context, including dashboard visualizations, audit reports, verification results, data exports, and/or other output. In some embodiments, the output comprises a dashboard visualization that displays a chronological record of digital fingerprints associated with real estate property data. In other embodiments, the output comprises an AI decision log that provides an immutable record of artificial intelligence decision data. The output is generated by combining data from both the application-specific distributed ledger, which provides immutability guarantees and verification capabilities, and the object-relational database, which provides complete fingerprint data and efficient querying. The output may also be rendered via an electronic interface for viewing by users or transmitted to external systems through API responses.

The term “consensus layer” refers to a global consensus layer (e.g., a network-wide consensus layer) that connects the application-specific distributed ledger to one or more other distributed ledgers. The consensus layer serves as the network-wide consensus layer that validates and finalizes metagraph snapshots, aggregating them into global snapshots that represent the canonical record of all activity across the network. When a hash data structure is added to the application-specific distributed ledger and included in a metagraph snapshot, the snapshot is submitted to the consensus layer for final consensus and permanent on-chain storage. Once a metagraph snapshot is accepted into a global snapshot by the consensus layer, the data is considered finalized and recorded on-chain with immutability guarantees. The consensus layer provides cross-network coordination, enabling metagraph distributed ledgers to interact with one another through globally ordered state updates. The consensus layer maintains the canonical record of all activity across the network, ensuring consistency and providing the foundation for trust guarantees through decentralized consensus where no single entity can unilaterally modify historical records.

In some embodiments, the consensus layer is configured as a hypergraph (e.g., a hypergraph layer) that connects the application-specific distributed ledger to one or more other distributed ledgers and provides final consensus for data storage. For example, the hypergraph may receive metagraph snapshots from the application-specific distributed ledger and validates them for inclusion in global snapshots that represent the canonical record of all activity across the network. Once a metagraph snapshot is accepted into a global snapshot by the hypergraph, the data is considered finalized and recorded on-chain with immutability guarantees. The hypergraph aggregates data from multiple distributed ledgers and maintains the canonical record of all activity across the network, ensuring consistency and providing cross-network coordination. The hypergraph provides the foundation for trust guarantees through decentralized consensus where no single entity can unilaterally modify historical records.

The term “dashboard visualization” refers to a graphical user interface that displays information associated with digital fingerprints based on data from the application-specific distributed ledger and the object-relational database. A dashboard visualization provides an electronic interface where users may view recent fingerprint submissions, access detailed information about individual fingerprints, and verify the integrity of stored data. The dashboard visualization may display fingerprint metadata including timestamps, signer identifiers, document references, and verification status indicators. In some embodiments, the dashboard visualization comprises a property history interface that displays a chronological record of digital fingerprints associated with real estate property data, including property attributes, utility information, warranty details, and/or maintenance records. The dashboard visualization may also display associated documents such as images or files that have been stored alongside their cryptographic fingerprints. In some embodiments, the dashboard visualization is rendered based on data retrieved from both the application-specific distributed ledger and the object-relational database. For instance, the application-specific distributed ledger may provide verification of on-chain status and the object-relational database may provides complete fingerprint data and associated metadata for display

The term “search query” refers to a request submitted via a search API to retrieve digital fingerprints from the object-relational database based on specified criteria. A search query enables users to locate specific fingerprint records by specifying search parameters such as document identifiers, timestamps, signer identifiers, organization identifiers, and/or other metadata fields. When a search query is received via the search API, the distributed ledger platform retrieves matching digital fingerprints from the object-relational database and causes the rendering of a dashboard visualization based on the search results. The search query functionality enables users to efficiently locate and verify specific fingerprint records among potentially large volumes of stored data. Search queries may be submitted through the electronic interface or programmatically through API calls, enabling integration with external systems and automated verification workflows.

The term “real estate property data” refers to digital data associated with one or more real estate asset events that is subject to fingerprinting for immutable storage and verification. Real estate property data encompasses documentation related to real estate properties including build materials, inspection photographs, permits, warranties, receipts, maintenance records, utility information, and other property-related information. The real estate property data may be generated throughout the lifecycle of a property, from initial construction through subsequent ownership transfers and ongoing maintenance. When real estate property data is fingerprinted and stored through the distributed ledger platform, it creates a verifiable record that can be used for insurance underwriting, property sales, rental management, and compliance verification. The dashboard visualization for real estate property data may comprise a property history interface that displays a chronological record of digital fingerprints associated with the property, enabling users to view the complete documented history of the real estate asset.

The term “AI decision data” refers to digital data associated with one or more inputs or prompts utilized by an AI model to generate AI model output. AI decision data encompasses the information used by artificial intelligence systems when making automated decisions, including input data, model parameters, decision logic, and resulting outputs. As regulations increasingly require documentation of algorithmic decision-making, particularly for decisions affecting credit worthiness, healthcare, or other significant outcomes, AI decision data provides the basis for creating immutable records of automated decisions. When AI decision data is fingerprinted and stored through the distributed ledger platform, it creates a verifiable audit trail that cannot be retroactively modified, addressing concerns about AI systems rewriting their own logs. The output generated from AI decision data may comprise an AI decision log that provides an immutable record of the inputs and logic used in automated decisions.

The terms “AI model(s)” “machine learning module,” “machine learning model,” “ML model(s),” “artificial intelligence model(s),” or “AI model(s)” refer to computational systems that implement machine learning or deep learning algorithms. The term “artificial intelligence” or “AI” refers broadly to computer systems designed to perform tasks that typically require human intelligence, including but not limited to reasoning, learning, problem-solving, perception, and natural language understanding. The term “machine learning” refers to a subset of artificial intelligence encompassing methods and algorithms that enable computer systems to learn patterns from data and make predictions or decisions without being explicitly programmed with rules for each specific scenario. Machine learning models are computer-implemented algorithms that may learn from data stored in databases or datastores, with or without relying on rules-based programming. These models enable reliable, repeatable decisions and results and facilitate the uncovering of hidden insights through machine-based learning from historical relationships and trends in the data. Machine learning models may be accessed by applications and services via APIs and may be deployed within service-oriented platforms. In some embodiments, a machine learning model such as the task duration prediction model is a neural network model. In some embodiments, a machine learning model such as the task duration prediction model is a generative model (e.g., a generative AI model). In some embodiments, a machine learning model such as the task duration prediction model is a large language model.

In some embodiments, an AI system that processes inputs to generate outputs through learned patterns and algorithms. An AI model may include machine learning models, neural networks, large language models, and other computational systems that perform automated analysis and decision-making. The AI model utilizes AI decision data as inputs and generates AI model output based on the learned patterns encoded within the model. In the context of the distributed ledger platform, AI models may interact with the system through an MCP server that enables AI tools to validate documents, verify fingerprints, search records, and generate audit reports through natural language interactions. The distributed ledger platform also supports payment negotiation protocols that allow AI agents to negotiate costs and submit payments directly, enabling autonomous agent workflows without pre-established service accounts.

Machine learning encompasses two primary learning paradigms: supervised learning and unsupervised learning. In supervised learning, a model is trained on a labeled dataset where each input example is paired with a corresponding target output or label. The model learns to map inputs to outputs by minimizing the difference between its predictions and the known labels. Examples of supervised learning tasks include classification (e.g., categorizing data into discrete classes such as spam detection, image recognition, or sentiment classification) and regression (e.g., predicting continuous values such as prices, temperatures, or durations). Common supervised learning algorithms include linear regression, logistic regression, support vector machines (SVMs), decision trees, random forests, gradient boosting machines (e.g., XGBoost, LightGBM, CatBoost), k-nearest neighbors (KNN), and neural networks. In unsupervised learning, a model is trained on unlabeled data and must discover patterns, structures, or relationships within the data without explicit guidance. Examples of unsupervised learning tasks include clustering (e.g., grouping similar data points together using algorithms such as k-means, hierarchical clustering, DBSCAN, or Gaussian mixture models), dimensionality reduction (e.g., reducing the number of features while preserving important information using techniques such as principal component analysis (PCA), t-SNE, or UMAP), and anomaly detection (e.g., identifying unusual patterns or outliers in data). Semi-supervised learning combines elements of both paradigms, using a small amount of labeled data alongside a larger amount of unlabeled data to improve model performance.

A machine learning model is initially fit or trained on a training dataset comprising a set of examples used to fit or adjust the parameters of the model. During training, the model processes input data, generates predictions or outputs, and compares these outputs against target values (in supervised learning) or optimization objectives (in unsupervised learning). Based on the result of this comparison and the specific learning algorithm being used, the parameters of the model are adjusted through optimization techniques such as gradient descent, stochastic gradient descent (SGD), Adam, RMSprop, or other optimization algorithms. Training data may be stored in databases or datastores and accessed via APIs. The training process typically involves iterating over the training data multiple times (epochs) until the model converges to a satisfactory level of performance. Model performance is evaluated using metrics appropriate to the task, such as accuracy, precision, recall, F1 score, area under the ROC curve (AUC-ROC), mean squared error (MSE), mean absolute error (MAE), or other evaluation metrics. The machine learning models as described herein may make use of multiple ML engines (e.g., for analysis, transformation, inference, and other needs). The system may train different ML models for different needs and different ML-based engines, generate new models based on gathered training data, and evaluate their performance against existing models

The term “feature engineering” refers to the process of using domain knowledge to select, transform, extract, or create input variables (features) from raw data to improve the performance of machine learning models. Feature engineering techniques include feature selection (identifying the most relevant features for a given task), feature extraction (deriving new features from existing data, such as extracting statistical measures, frequency components, or textual features), feature transformation (applying mathematical transformations such as normalization, standardization, log transformation, or polynomial expansion), and feature encoding (converting categorical variables into numerical representations using techniques such as one-hot encoding, label encoding, or target encoding). Effective feature engineering may significantly impact model accuracy and generalization capability. Automated feature engineering tools and techniques, such as those provided by frameworks like Featuretools, AutoML systems (e.g., Google AutoML, H2O AutoML, Auto-sklearn), or feature stores (e.g., Feast, Tecton, Amazon SageMaker Feature Store), may assist in discovering and managing features at scale within service-oriented platforms.

Deep learning represents a subset of machine learning that utilizes artificial neural networks with multiple layers (deep neural networks) to learn hierarchical representations of data. Neural network architectures include feedforward neural networks, convolutional neural networks (CNNs) for image and spatial data processing (e.g., ResNet, VGG, EfficientNet, YOLO for object detection), recurrent neural networks (RNNs) and long short-term memory networks (LSTMs) for sequential data processing, and transformer architectures for natural language processing and other sequence-to-sequence tasks. Deep learning frameworks such as TensorFlow, PyTorch, JAX, Keras, and MXNet provide tools for building, training, and deploying neural network models. Deep learning models may be trained on specialized hardware including graphics processing units (GPUs) from manufacturers such as NVIDIA (e.g., A100, H100, RTX series) and AMD, tensor processing units (TPUs) from Google, and other AI accelerators. Model training may be distributed across multiple computing nodes within cloud computing environments provided by Amazon Web Services, Microsoft Azure, Google Cloud Platform, or other cloud providers.

The term “generative AI” or “generative artificial intelligence” refers to a category of artificial intelligence systems designed to generate new content, including text, images, audio, video, code, or other data types. Generative AI models learn patterns and structures from training data and use this learned knowledge to create novel outputs that resemble the training data distribution. Examples of generative AI architectures include generative adversarial networks (GANs), which consist of a generator network that creates synthetic data and a discriminator network that distinguishes between real and generated data (e.g., StyleGAN, BigGAN, CycleGAN); variational autoencoders (VAEs), which learn compressed latent representations of data and can generate new samples by sampling from the latent space; diffusion models, which learn to reverse a gradual noising process to generate high-quality samples (e.g., Stable Diffusion, DALL-E, Midjourney, Imagen); and autoregressive models, which generate sequences by predicting one element at a time based on previously generated elements. Generative AI applications include text generation, image synthesis, music composition, audio generation, video generation, code generation (e.g., GitHub Copilot, Amazon CodeWhisperer, Tabnine), and creative content production. Generative AI models may be deployed within service-oriented platforms and accessed via APIs.

Large language models (LLMs) represent a specialized category of generative AI models designed to understand, generate, and manipulate human language. These models, such as GPT (Generative Pre-trained Transformer) series from OpenAI (e.g., GPT-3.5, GPT-4, GPT-4o), Claude from Anthropic, LLaMA and Llama 2 from Meta, PaLM and Gemini from Google, BERT (Bidirectional Encoder Representations from Transformers), RoBERTa, T5, Falcon, Mistral, and Cohere models, are typically built using transformer architectures with parameters ranging from millions to hundreds of billions. The training process for LLMs involves multiple phases: pre-training on vast corpora of text data (often hundreds of gigabytes to terabytes of text from sources such as web pages, books, articles, and code repositories) to learn general language patterns, syntax, semantics, and world knowledge; followed by fine-tuning on domain-specific datasets to specialize the model for particular applications. For software development support applications and other specialized use cases, LLMs may undergo additional reinforcement learning from human feedback (RLHF) or reinforcement learning from AI feedback (RLAIF), where human evaluators or AI systems rate model outputs to improve response quality, helpfulness, harmlessness, and alignment with organizational policies. Constitutional AI (CAI) represents another alignment technique where models are trained to follow specified principles or guidelines. LLM inference may be performed via APIs provided by model providers or through self-hosted deployments within enterprise environments.

LLMs and other machine learning models can be further enhanced through techniques such as retrieval-augmented generation (RAG), which allows models to access and incorporate external knowledge bases, databases, or datastores during inference, making them particularly effective for technical support scenarios, question answering systems, and other applications where accurate, up-to-date information is critical. RAG systems typically combine a retrieval component (which searches for relevant documents or passages from a knowledge base using vector similarity search or other retrieval methods) with a generation component (which synthesizes retrieved information into coherent responses). Other enhancement techniques include prompt engineering (crafting effective input prompts to elicit desired model behaviors), few-shot learning (providing examples within the prompt to guide model responses), chain-of-thought prompting (encouraging step-by-step reasoning), and model fine-tuning using techniques such as Low-Rank Adaptation (LoRA), QLoRA, or full fine-tuning on domain-specific datasets. Machine learning models may implement various algorithms beyond neural networks, including ensemble methods (e.g., bagging, boosting, stacking), Bayesian methods, genetic algorithms, and reinforcement learning algorithms (e.g., Q-learning, policy gradient methods, actor-critic methods).

The ML models may undergo a training or learning phase before they are released into a production or runtime phase, or may begin operation with pre-trained models from existing systems or model repositories (e.g., Hugging Face Model Hub, TensorFlow Hub, PyTorch Hub, NVIDIA NGC). During a training or learning phase, the ML models may be tuned to focus on specific variables, to reduce error margins, to prevent overfitting through regularization techniques (e.g., L1/L2 regularization, dropout, early stopping), or to otherwise optimize their performance through hyperparameter tuning using techniques such as grid search, random search, Bayesian optimization, or automated hyperparameter optimization tools (e.g., Optuna, Ray Tune, Hyperopt). The ML models may initially receive input from a wide variety of data stored in databases or datastores, such as the gathered data described herein. Model versioning and experiment tracking may be managed using MLOps tools such as MLflow, Weights & Biases, Neptune, or Kubeflow. The ML models herein may undergo subsequent training phases for retraining, fine-tuning, or continuous learning to adapt to new data distributions or changing requirements. Model deployment may occur within containerized environments using technologies such as Docker and Kubernetes, with model serving frameworks such as TensorFlow Serving, TorchServe, Triton Inference Server, or Seldon Core enabling scalable inference within service-oriented platforms.

The term “distributed ledger platform” refers to a computing infrastructure that provides secure data fingerprinting and immutable data storage services through a combination of centralized and decentralized components. The distributed ledger platform includes an API endpoint that receives API data structures from client devices, a centralized processing layer that handles the processing and aggregation of digital fingerprints, an application-specific distributed ledger that stores hash data structures and validates data against domain-specific schemas, an object-relational database that stores aggregated digital fingerprint data structures for retrieval and querying, and a consensus layer that provides global consensus and cross-network coordination. The distributed ledger platform combines the accessibility of a RESTful API with the trust and immutability benefits of a public distributed ledger, enabling integration with existing data pipelines and workflow systems without requiring specialized knowledge of blockchain protocols. The hybrid architecture enables the distributed ledger platform to maintain high data throughput even during temporary outages of the distributed ledger components, as the centralized processing layer may queue incoming fingerprints until the decentralized components become available.

The term “API endpoint” refers to a network-accessible interface that receives API data structures from client devices and initiates processing within the distributed ledger platform. The API endpoint provides a RESTful API interface that abstracts the complexity of blockchain interaction, enabling client devices to submit digital fingerprints through standard HTTP protocols without requiring specialized knowledge of distributed ledger protocols. When an API data structure is received at the API endpoint, the data is passed to the centralized processing layer for validation, aggregation, and subsequent storage operations. The API endpoint may support multiple operations including fingerprint submission, search queries, document uploads, and verification requests. The API endpoint enables the distributed ledger platform to integrate with existing systems and data pipelines through defined API conventions.

The term “centralized processing layer” refers to a computing component within the distributed ledger platform that may handle the processing of digital fingerprints received through the API endpoint. The centralized processing layer aggregates multiple digital fingerprints into an aggregated digital fingerprint data structure using a hierarchical tree structure, generates a hash data structure from the aggregated data, and coordinates storage operations with both the application-specific distributed ledger and the object-relational database. In some embodiments, the centralized processing layer may batch incoming fingerprint requests over a period of time before generating the aggregated digital fingerprint data structure, enabling the system to process larger volumes of fingerprint submissions while minimizing the data stored on the distributed ledger. The centralized processing layer may also provides data availability during temporary outages of the distributed ledger components by queuing incoming fingerprints until the application-specific distributed ledger and consensus layer become available. The centralized processing layer communicates with the application-specific distributed ledger to submit hash data structures for validation and storage, and with the object-relational database to store aggregated digital fingerprint data structures for retrieval and querying purposes.

### Example System Architechture

FIG. 1 illustrates a block diagram of a system that can be specially configured within which embodiments of the present disclosure may operate. Specifically, FIG. 1 illustrates an example system 100 for secure data fingerprinting and immutable data storage. The example system 100 includes a digital evidence apparatus 102, a distributed ledger platform 104, a client device 112, and a network 114. The distributed ledger platform 104 includes an API endpoint 103, a centralized processing layer 105, an application-specific distributed ledger 106, an object-relational database 108, and a consensus layer 110. In one or more embodiments, the system 100 includes at least the network 114 that enables transmission of data between one or more subsystem(s) and/or device(s) of the system 100.

The digital evidence apparatus 102 includes one or more computer(s) embodied in hardware, software, firmware, and/or a combination thereof. In some embodiments, the digital evidence apparatus 102 includes one or more application server(s), database server(s), enterprise computing terminal(s), and/or the like that are configured to perform the functionality described herein. In some embodiments, the digital evidence apparatus 102 embodies or includes a backend system (e.g., one or more enterprise server(s)) that are communicable over one or more network(s) (e.g., via the Internet). Additionally or alternatively, in some embodiments, the digital evidence apparatus 102 includes one or more virtual computer(s) embodied in a software environment maintained via particular hardware, for example where the digital evidence apparatus 102 is maintained as a virtual environment on hardware of a central terminal supporting multiple software application(s). In some embodiments, the digital evidence apparatus 102 includes one or more hardware device(s) within the same physically defined space, such as a data warehouse, company headquarters, and/or the like associated with a particular entity. Alternatively or additionally, in some embodiments, the digital evidence apparatus 102 includes one or more hardware and/or software device(s) located remotely from one another and that communicate in conjunction with one another to provide the described functionality, for example embodied by one or more cloud computing system(s).

In some embodiments, the digital evidence apparatus 102 includes a plurality of sub-services that each support a portion of the functionality performed by the digital evidence apparatus 102. In some such embodiments, the plurality of sub-services may each be embodied by different hardware, software, firmware, and/or any combination thereof. Alternatively or additionally, in some embodiments, one or more of the sub-services share particular hardware, software, firmware, and/or any combination thereof. For example, in some embodiments, the digital evidence apparatus 102 may embody specially-configured software applications executed on shared hardware. In some embodiments, the digital evidence apparatus 102 is communicatively coupled to the distributed ledger platform 104 and interacts with the centralized processing layer 105 to facilitate the creation, validation, and/or storage of digital fingerprints within the system 100.

The client device 112 communicates with the distributed ledger platform 104 via the network 114. For example, the client device 112 may transmit an API data structure that comprises a digital fingerprint 120 for digital data associated with the client device 112. In some embodiments, the client device 112 may be a user device and/or end terminal accessible by a user to initiate functionality via the digital evidence apparatus 102. For example, in some embodiments, a user enters authentication credentials via the client device 112 that are validated to initiate an authenticated session associated with the digital evidence apparatus 102, such that the user may utilize the client device 112 to access functionality of the digital evidence apparatus 102 associated with data fingerprinting and verification. In other embodiments, the client device 112 is a sensor device that automatically generates sensor data for inclusion in the digital fingerprint 120. The client device 112 in some embodiments is utilized to initiate one or more indication(s) of a fingerprint submission request. Additionally or alternatively, in some embodiments, the client device 112 or another client device is utilized to render electronic interface(s) that provide details associated with fingerprint verification, dashboard visualizations, and/or the like. In some such embodiments, the client device 112 operates as a front-end or user-facing application for accessing such functionality of the digital evidence apparatus 102.

The digital fingerprint 120 may include a cryptographic hash of data content along with associated metadata and identifiers. In some embodiments, the digital fingerprint includes an organization identifier, a tenant identifier, an event identifier that uniquely identifies the particular fingerprint submission, a document identifier that references a document in the client's system, a document reference comprising the cryptographic hash of the document content, a timestamp, a version number, and/or a signer identifier comprising a public key. In some embodiments, the client device 112 signs the fingerprint payload with a private key and provides the signature along with the public key, enabling verification that the client device 112 was the entity that signed and certified the data.

The distributed ledger platform 104 includes the API endpoint 103 that receives the API data structure from the network 114. The API endpoint 103 may be connected to the centralized processing layer 105, which handles the processing of digital fingerprints received through the API endpoint 103. In some embodiments, the API endpoint 103 provides a RESTful API interface that abstracts the complexity of blockchain interaction, enabling integration with existing data pipelines and workflow systems without requiring specialized knowledge of distributed ledger protocols. The centralized processing layer 105 may communicate with the application-specific distributed ledger 106 and the object-relational database 108.

The centralized processing layer 105 aggregates multiple digital fingerprints into an aggregated digital fingerprint data structure using a hierarchical tree structure. In some embodiments, the hierarchical tree structure comprises a Merkle tree (e.g., a Patricia Merkle tree) that maps multiple digital fingerprints to a single cryptographic hash. The centralized processing layer 105 generates a hash data structure from the aggregated digital fingerprint data structure and adds the hash data structure to the application-specific distributed ledger 106. In some embodiments, the centralized processing layer 105 batches incoming fingerprint requests over a period of time before generating the aggregated digital fingerprint data structure, enabling the system 100 to process larger volumes of fingerprint submissions while minimizing the data stored on the distributed ledger. For example, thousands of individual digital fingerprints may be represented by a single hash data structure on-chain.

The application-specific distributed ledger 106 stores hash data structures generated from aggregated digital fingerprint data structures. In some embodiments, the application-specific distributed ledger 106 operates as a custom blockchain that defines its own consensus rules, data models, and/or validation logic while connecting to a broader network for global consensus. The application-specific distributed ledger 106 validates incoming data against a validation rule set that defines a domain-specific data schema for the application-specific distributed ledger 106. In some embodiments, the application-specific distributed ledger 106 includes multiple layer components including a currency layer for token transactions and a data layer for domain-specific custom data updates. The application-specific distributed ledger 106 packages validated data into metagraph snapshots, which represent a finalized state of the application-specific distributed ledger.

The object-relational database 108 stores the aggregated digital fingerprint data structures for retrieval and querying purposes. In some embodiments, the object-relational database 108 comprises a Postgres database that maintains the complete fingerprint data including all metadata fields, signatures, and references to associated documents. The object-relational database 108 enables search functionality and dashboard visualization rendering based on the stored fingerprint data. In some embodiments, the object-relational database 108 includes read replica components that handle read operations separately from write operations to improve system performance and availability.

The application-specific distributed ledger 106 is connected to the consensus layer 110 which serves as a global consensus layer that connects the application-specific distributed ledger 106 to one or more other distributed ledgers. The consensus layer 110 receives validated data from the application-specific distributed ledger 106 and finalizes the data for inclusion in global snapshots, providing immutability and cross-network coordination. In some embodiments, once a metagraph snapshot is accepted into a global snapshot by the consensus layer 110, the data is considered finalized and recorded on-chain with immutability guarantees. The consensus layer 110 aggregates data from multiple distributed ledgers and maintains the canonical record of all activity across the network.

The system 100 operates by receiving digital fingerprints from the client device 112 through the network 114 and the API endpoint 103. The centralized processing layer 105 aggregates multiple digital fingerprints into an aggregated digital fingerprint data structure using a hierarchical tree structure, generates a hash data structure from the aggregated data, and adds the hash data structure to the application-specific distributed ledger 106. The aggregated digital fingerprint data structure is stored in the object-relational database 108 for subsequent retrieval and visualization purposes. The application-specific distributed ledger 106 submits finalized snapshots to the consensus layer 110 for global consensus and permanent on-chain storage.

The network 114 can be a communications network and/or can be configurable to be embodied in any of a myriad of network configurations. In some embodiments, the network 114 embodies a public network (e.g., the Internet). In some embodiments, the network 114 embodies a private network (e.g., an internal, localized, or closed-off network between particular devices). In some other embodiments, the network 114 embodies a hybrid network (e.g., a network enabling internal communication between particular connected devices and external communication with other devices). The network 114 in some embodiments includes one or more base station(s), relay(s), router(s), switch(es), cell tower(s), communications cable(s) and/or associated routing station(s), and/or the like. In some embodiments, the network 114 includes one or more computing device(s) controlled by individual entities (e.g., an entity-owner router and/or modem) and/or one or more external utility devices (e.g., Internet service provider communication tower(s) and/or other device(s)).

The computing devices of the system 100 may each communicate in whole or in part over a portion of one or more communication network(s), such as the network 114. For example, each of the components of the system 100 can be communicatively coupled to transmit data to and/or receive data from one another over the same and/or different wireless or wired networks embodying the network 114. Non-limiting examples of network configuration(s) for the network 114 include, without limitation, a wired or wireless Personal Area Network (PAN), Local Area Network (LAN), Metropolitan Area Network (MAN), Wide Area Network (WAN), and/or the like. Additionally, while FIG. 1 illustrates certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary. Alternatively or additionally still, in some embodiments the network 114 enables communication to one or more other computing device(s) not depicted, for example client device(s) for accessing functionality of any of the subsystems therein via native and/or web-based application(s), and/or the like.

In some embodiments, the digital evidence apparatus 102 supports automatically receiving data transmissions (e.g., the API data structure), for example embodied by API request(s), procedure call(s), and/or other digital data transfers, that embody a fingerprint submission request. Additionally or alternatively, in some embodiments, the digital evidence apparatus 102 supports providing data via API request(s), procedure call(s), and/or other digital data transfers, that embody a response including confirmation of fingerprint storage, verification results, and/or dashboard visualization data. In some embodiments, the hybrid architecture of the system 100 enables the distributed ledger platform 104 to maintain high data throughput even during temporary outages of the distributed ledger components, as the centralized processing layer 105 may queue incoming fingerprints until the application-specific distributed ledger 106 and/or the consensus layer 110 become available.

The computing devices of the system 100 may each communicate in whole or in part over a portion of one or more communication network(s), such as the network 114. For example, each of the components of the system 100 can be communicatively coupled to transmit data to and/or receive data from one another over the same and/or different wireless or wired networks embodying the network 114. Additionally, while FIG. 1 illustrate certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary. Alternatively or additionally still, in some embodiments the network 114 enables communication to one or more other computing device(s) not depicted, for example client device(s) for accessing functionality of any of the subsystems therein via native and/or web-based application(s), and/or the like.

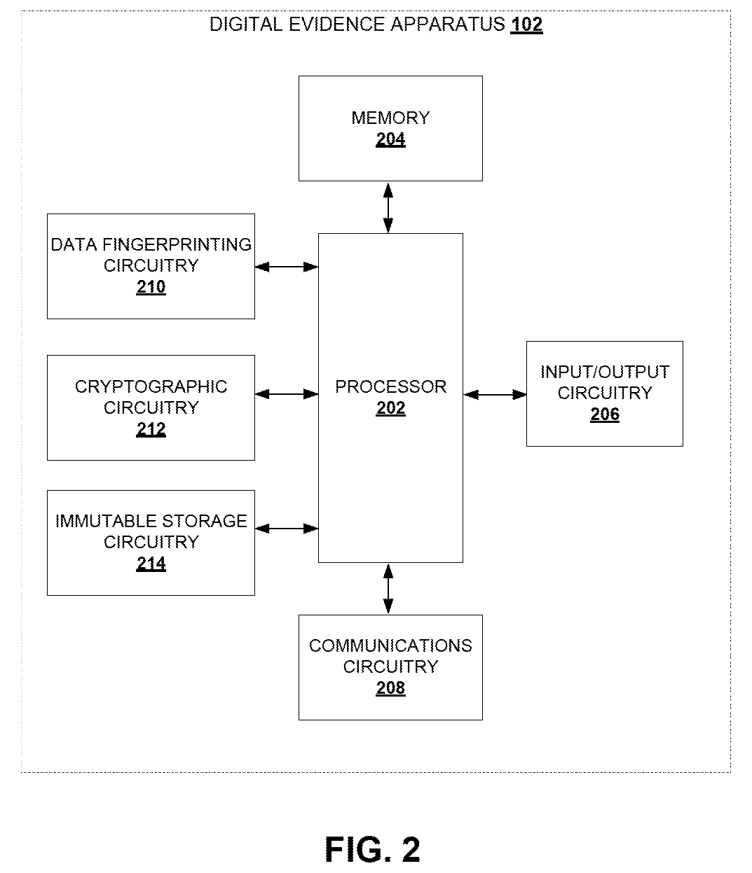

FIG. 2 illustrates a block diagram of an example apparatus that can be specially configured in accordance with at least one example embodiment of the present disclosure. Specifically, FIG. 2 illustrates the digital evidence apparatus 102 in accordance with at least one example embodiment of the present disclosure. The digital evidence apparatus 102 includes processor 202, memory 204, input/output circuitry 206, communications circuitry 208, data fingerprinting circuitry 210, cryptography circuitry 212, and immutable storage circuitry 214. In some embodiments, the digital evidence apparatus 102 is configured, using one or more of the sets of circuitry 206, 208, 210, 212, and/or 214, to execute and perform one or more of the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the digital evidence apparatus 102 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the digital evidence apparatus 102 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the digital evidence apparatus 102. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the digital evidence apparatus 102 to carry out various functions in accordance with example embodiments of the present disclosure.

The processor 202 can be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the digital evidence apparatus 102, and/or one or more remote or “cloud” processor(s) external to the digital evidence apparatus 102.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes or is embodied by a CPU, microprocessor, and/or the like that executes computer-coded instructions, for example stored via the non-transitory memory 204.

In some embodiments, the digital evidence apparatus 102 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as an electronic interface, a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor can be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 includes hardware, software, firmware, and/or a combination thereof, that facilitates simultaneously display of particular data via a plurality of different devices.

In some embodiments, the digital evidence apparatus 102 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the digital evidence apparatus 102. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device, capture device, and/or other external computing device in communication with the digital evidence apparatus 102.

In some embodiments, the digital evidence apparatus 102 includes the data fingerprinting circuitry 210. The data fingerprinting circuitry 210 includes hardware, software, firmware, and/or a combination thereof, that supports various functionality associated with receiving and/or aggregating API data structures. For example, in some embodiments, the data fingerprinting circuitry 210 includes hardware, software, firmware, and/or a combination thereof, that receives an API data structure that comprises a digital fingerprint (e.g., the digital fingerprint 120) for digital data associated with a client device event. In some embodiments, the data fingerprinting circuitry 210 includes hardware, software, firmware, and/or a combination thereof, that aggregates the digital fingerprint (e.g., the digital fingerprint 120) with one or more other digital fingerprints to generate an aggregated digital fingerprint data structure that maps the digital fingerprint and the one or more other digital fingerprints via a hierarchical tree structure. Additionally or alternatively, in some embodiments, the data fingerprinting circuitry 210 includes hardware, software, firmware, and/or a combination thereof, that enables access to one or more API(s), FTP connection(s), and/or the like to securely acquire, receive, retrieve, and/or otherwise identify data from one or more system(s) external from the digital evidence apparatus 102. In some embodiments, the data fingerprinting circuitry 210 includes a separate processor, specially configured field programmable gate array (FPGA), or a specially programmed application specific integrated circuit (ASIC).

In some embodiments, the digital evidence apparatus 102 includes the cryptography circuitry 212. The cryptography circuitry 212 includes hardware, software, firmware, and/or a combination thereof, that supports various functionality associated with generating and/or managing a hash data structure. For example, in some embodiments, the cryptography circuitry 212 includes hardware, software, firmware, and/or a combination thereof, that generates a hash data structure based at least in part on the aggregated digital fingerprint data structure. Additionally or alternatively, in some embodiments, the cryptography circuitry 212 includes hardware, software, firmware, and/or a combination thereof, that enables access to one or more API(s), FTP connection(s), and/or the like to securely acquire, receive, retrieve, and/or otherwise identify data from one or more system(s) external from the digital evidence apparatus 102. In some embodiments, the cryptography circuitry 212 includes a separate processor, specially configured FPGA, or a specially programmed ASIC.

In some embodiments, the digital evidence apparatus 102 includes the immutable storage circuitry 214. The immutable storage circuitry 214 includes hardware, software, firmware, and/or a combination thereof, that supports various functionality associated with the application-specific distributed ledger 106, the consensus layer 110, and/or the object-relational database 108. For example, in some embodiments, the immutable storage circuitry 214 includes hardware, software, firmware, and/or a combination thereof, that adds the hash data structure to an application-specific distributed ledger (e.g., the application-specific distributed ledger 106) based at least in part on a validation rule set that defines a domain-specific data schema for the application-specific distributed ledger. In some embodiments, the immutable storage circuitry 214 includes hardware, software, firmware, and/or a combination thereof, that stores the aggregated digital fingerprint data structure in an object-relational database (e.g., the object-relational database 108). In some embodiments, the immutable storage circuitry 214 includes a separate processor, specially configured FPGA, or a specially programmed ASIC.

In some embodiments, the input/output circuitry 206 includes hardware, software, firmware, and/or a combination thereof, that generates an output associated with the digital fingerprint based at least in part on (i) the hash data structure added to the application-specific distributed ledger and (ii) the aggregated digital fingerprint data structure stored in the object-relational database. For example, in some embodiments, the input/output circuitry 206 includes hardware, software, firmware, and/or a combination thereof, that causes a rendering of a dashboard visualization associated with the digital fingerprint via an electronic interface based at least in part on (i) the hash data structure added to the application-specific distributed ledger and (ii) the aggregated digital fingerprint data structure stored in the object-relational database.

Additionally or alternatively, in some embodiments, two or more of the sets of circuitries 202-214 are combinable. Alternatively or additionally, in some embodiments, one or more of the sets of circuitry perform some or all of the functionality described associated with another component. For example, in some embodiments, two or more of the sets of circuitry 206-214 are combined into a single module embodied in hardware, software, firmware, and/or a combination thereof. Similarly, in some embodiments, one or more of the sets of circuitry, for example the data fingerprinting circuitry 210, cryptography circuitry 212, and/or immutable storage circuitry 214, is/are combined with the processor 202, such that the processor 202 performs one or more of the operations described above with respect to each of these sets of circuitry 210-214. Additionally, one or more of the sets of circuitry, for example the data fingerprinting circuitry 210, cryptography circuitry 212, and/or immutable storage circuitry 214, and/or the processor 202 may be communicatively coupled to and/or integrated with the centralized processing layer 105.

In some embodiments, one or more external systems (such as a remote cloud computing and/or data storage system) may also be leveraged to provide at least some of the functionality discussed herein.

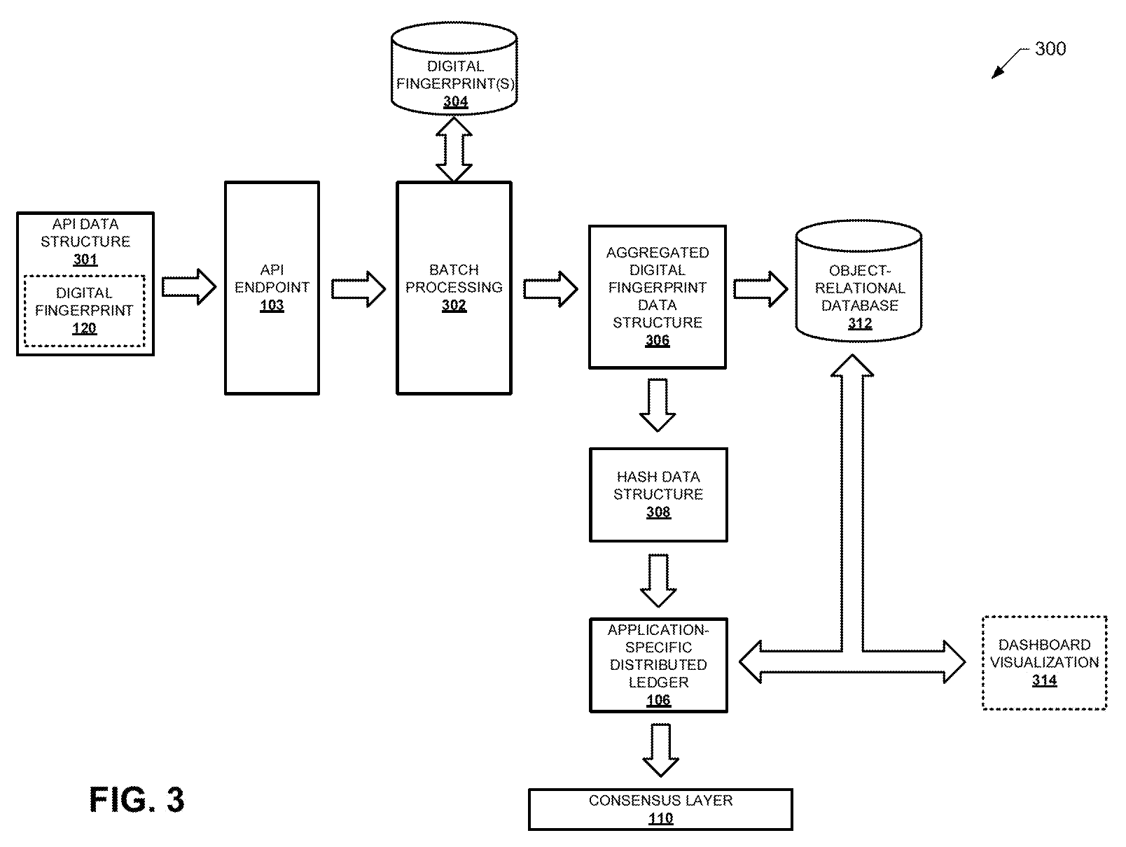

Referring to FIG. 3, an example data flow system 300 for secure data fingerprinting and immutable data storage is presented in accordance with one or more embodiments of the present disclosure. The data flow system 300 depicts the data flow and component interactions within the distributed ledger platform, illustrating how digital fingerprints are received, aggregated, stored, and visualized through the coordination of centralized and decentralized components. Additionally, the data flow 300 depicts functionality between the various sub-systems of the system 100, including the digital evidence apparatus 102.

As illustrated in the data flow system 300, an API data structure 301 may be received via the API endpoint 103. The API data structure 301 may include the digital fingerprint 120. Additionally, the API data structure 301 may be transmitted by the client device 112. The API endpoint 103 may provide an API interface to enable client devices such as the client device 112 to submit digital fingerprints through defined HTTP protocols. In some embodiments, the digital fingerprint 120 comprises a cryptographic hash of digital data associated with a client device event. The digital fingerprint may further comprise at least one of a timestamp and/or an entity identifier that enable identification, verification, and retrieval of the fingerprinted data.

Batch processing 302 may aggregate the digital fingerprint 120 with one or more other digital fingerprints 304 to generate an aggregated digital fingerprint data structure 306. In some embodiments, the API endpoint 103 communicates bidirectionally with digital fingerprint(s) 304, allowing for the exchange of fingerprint data between the API layer and the processing components of the data flow system 300. The digital fingerprint(s) 304 represent individual fingerprint submissions received from client devices, where each digital fingerprint includes metadata fields such as an organization identifier, a tenant identifier, an event identifier that uniquely identifies the particular fingerprint submission, a document identifier that references a document in the client's system, a document reference comprising the cryptographic hash of the document content, a timestamp, a version number, and/or a signer identifier comprising a public key. Additionally or alternatively, the batch processing 302 may communicate bidirectionally with the digital fingerprint(s) 304, enabling the retrieval and organization of fingerprint data for aggregation operations. The aggregated digital fingerprint data structure 306 may map the digital fingerprint 120 and the digital fingerprint(s) 304 via a hierarchical tree structure. This aggregation approach enables the data flow system 300 to process larger volumes of fingerprint submissions while minimizing the data stored on the distributed ledger.

In some embodiments, the batch processing 302 is triggered based on a particular time interval (e.g., a 10 second spacing, etc.) between batch operations. Additionally or alternatively, the batch processing 302 may operate in a continuous mode to respond to back pressure conditions when incoming fingerprint submissions exceed processing capacity. The batch processing 302 may also implement a retry mechanism to handle transient failures and/or rate limits on the total number of fingerprints per batch to enable consistent processing performance. When aggregating digital fingerprints into the aggregated digital fingerprint data structure 306, the fingerprints may be ordered based on an arrival timestamp at the server. However, the lookup key for each fingerprint may also comprise a tuple of unique identifiers (e.g., UUIDs) such that the sorting of the fingerprints within the batch does not impact the ability to retrieve individual fingerprints from the aggregated digital fingerprint data structure 306.

In some embodiments, the hierarchical tree structure comprises a Merkle tree that maps the digital fingerprint 120 and the digital fingerprint(s) 304to a cryptographic hash. In an example, the Merkle tree may be a Patricia Merkle tree that provides additional efficiency for storing attestations of large amounts of data with a compact root hash. This hierarchical organization enables verification of individual digital fingerprints through validation proofs that demonstrate inclusion within the tree structure while representing numerous individual digital fingerprints with a single hash data structure stored on-chain.

The aggregated digital fingerprint data structure 306 may then be utilized by the digital evidence apparatus 102 to generate a hash data structure 308. The hash data structure 308 may represent a compact cryptographic representation of the aggregated fingerprints. The hash data structure 308 comprises the root hash of the hierarchical tree structure along with any associated metadata required for validation and retrieval operations. The hash data structure 308 serves as the immutable anchor point against which individual digital fingerprints can be verified through validation proofs.

The hash data structure 308 may be provided to the application-specific distributed ledger 106 for validation and immutable storage. The application-specific distributed ledger 106 operates as a specially-configured distributed ledger that defines its own consensus rules, data models, and/or validation logic while connecting to a broader network for global consensus. In some embodiments, the hash data structure 308 is added to the application-specific distributed ledger 106 based at least in part on a validation rule set that defines a domain-specific data schema for the application-specific distributed ledger 106. The validation rule set specifies the structure, format, and constraints that incoming data must satisfy to be accepted for storage, including rules for verifying cryptographic signatures, checking data format compliance, validating timestamp ordering, confirming authorization of submitting entities, and/or enforcing domain-specific logic.

In some embodiments, the application-specific distributed ledger 106 utilizes a validation rule set and a consensus mechanism that work together to enable data integrity and agreement among network participants. For example, the consensus mechanism may be part of the underlying framework for the distributed ledger, while the validation rule set may define one or more rules that maintain an application-specific state for the distributed ledger. In some embodiments, the validation rule set may include one or more rules such as verifying that a timestamp of a latest update is after a timestamp of a previous update, confirming that an update originated from a known and authorized update signer, and/or other domain-specific validation logic. The validation functionality may also operate on a transaction of the application-specific distributed ledger 106. For example, the transaction may include the rolled-up information from the root hash of the individual digital fingerprint updates. The validation rule set may also be configured based on data schemas and/or other application-specific behavior of the application-specific distributed ledger 106. As such, by combining user-defined validation logic with the underlying consensus mechanism, the application-specific distributed ledger 106 provides both application-specific flexibility and the security guarantees of decentralized consensus.

The application-specific distributed ledger 106 may also communicate with the consensus layer 110. For instance, the consensus layer 110 may serve as a global consensus layer connecting the application-specific distributed ledger 106 to one or more other distributed ledgers in the network. In some embodiments, based at least in part on the hash data structure 308 being added to the application-specific distributed ledger 106, at least a portion of the hash data structure 308 is transmitted to the consensus layer 110. The consensus layer 110 receives validated data from the application-specific distributed ledger 106 and finalizes the data for inclusion in global snapshots, providing immutability and cross-network coordination. Once a metagraph snapshot is accepted into a global snapshot by the consensus layer 110, the data may be considered finalized and recorded on-chain with immutability guarantees.

In some embodiments, the application-specific distributed ledger 106 submits snapshots to the consensus layer 110 based on a consensus mechanism managed by a framework of the the application-specific distributed ledger 106. For example, the consensus mechanism may comprise a majority-signer round-based Byzantine Fault Tolerant (BFT) algorithm with time-based and event-based triggers to append new snapshots to the chain state of the application-specific distributed ledger 106. Each new snapshot on the application-specific distributed ledger 106 may also push a binary data object to the consensus layer 110, which may be comprised of public node operators executing their own consensus operations to append snapshots to their chain state. In some embodiments, the consensus layer 110 creates snapshots at particular intervals (e.g., intervals ranging from approximately 10 to 60 seconds on average, etc), while the application-specific distributed ledger 106, which may have fewer nodes participating in consensus, may be configured based on a lower interval between snapshots (e.g., approximately 5 to 15 seconds between snapshots, etc.). Additionally, each snapshot may itself contain multiple updates, enabling additional scaling at each layer. For instance, the consensus layer 110 may include multiple state channels in a manner similar to how the application-specific distributed ledger 106 aggregates multiple transactions or hash data structures into a single snapshot. This layered snapshot architecture enables the distributed ledger platform 104 to scale efficiently by aggregating data at multiple levels before commitment to the consensus layer 110.

The aggregated digital fingerprint data structure 306 is also stored in an object-relational database 312, which maintains the complete fingerprint data for retrieval and querying purposes. For instance, the object-relational database 312 may receive data from both the aggregated digital fingerprint data structure 306 and the application-specific distributed ledger 106. In some embodiments, the object-relational database 312 comprises a Postgres database that maintains the complete fingerprint data including all metadata fields, signatures, and references to associated documents. The object-relational database 312 may store data using a schema that includes a primary key structure comprising block ordinal, timestamp, and hash, along with fields for signature and block identifiers, primary fields, and/or document values stored in JSON format.

In some embodiments, the object-relational database 312 synchronizes with the application-specific distributed ledger 106 and the consensus layer 110 to provide consistency between the aggregated digital fingerprint data structure 306 and the hash data structure 308. For example, an indexer application may monitor both the chain state of the application-specific distributed ledger 106 and the chain state of the consensus layer 110 to track the status of submitted data. Once the data reaches the consensus layer 110, the data may be marked as immutable within the object-relational database 312. As such, nodes to collectively move may forward to the next snapshot without waiting on a confirmation depth to resolve. This may further enable the object-relational database 312 to promptly update the status of stored fingerprint records to reflect their immutable on-chain status, enabling accurate verification status information that is consistent with the state of the application-specific distributed ledger 106 and the consensus layer 110 to be received when querying the object-relational database 312.

Based on the hash data structure 308 added to the application-specific distributed ledger 106 and the aggregated digital fingerprint data structure 306 stored in the object-relational database 312, an output associated with the digital fingerprint 120 may be generated. In some embodiments, a dashboard visualization 314 is rendered based on data from both the application-specific distributed ledger 106 and the object-relational database 312, providing a user interface for viewing and searching fingerprint records. In some embodiments, the data flow system 300 causes a rendering of the dashboard visualization 314 associated with the digital fingerprint via an electronic interface based at least in part on the hash data structure 308 added to the application-specific distributed ledger 106 and the aggregated digital fingerprint data structure 306 stored in the object-relational database 312. The dashboard visualization 314 provides an interface where users may view recent fingerprint submissions, access detailed information about individual fingerprints, and verify the integrity of stored data.

In some embodiments, the data flow system 300 receives a search query via a search API, retrieves the digital fingerprint from the object-relational database 312 based at least in part on the search query, and causes the rendering of the dashboard visualization 314 based at least in part on the search query. The search query enables users to locate specific fingerprint records by specifying search parameters such as document identifiers, timestamps, signer identifiers, organization identifiers, and/or other metadata fields.

In some embodiments, the data flow system 300 receives a document data structure associated with the digital fingerprint, verifies that a first hash of the document data structure matches a second hash of the digital fingerprint, correlates the document data structure with the aggregated digital fingerprint data structure 306 stored in the object-relational database 312, and generates output based at least in part on the hash data structure 308 added to the application-specific distributed ledger 106, the aggregated digital fingerprint data structure 306 stored in the object-relational database 312, and the document data structure. This capability enables users to store original documents, such as images or files, alongside their cryptographic fingerprints to provide a complete audit trail of both the proof and the source material.

In some embodiments, the digital data associated with the digital fingerprint comprises real estate property data associated with one or more real estate asset events. The dashboard visualization 314 may comprise a property history interface that displays a chronological record of digital fingerprints associated with the real estate property data. For instance, the data flow system 300 may receive a first digital fingerprint for a first image associated with a real estate asset and a second digital fingerprint for a second image associated with the real estate asset, aggregate the first digital fingerprint and the second digital fingerprint to generate the aggregated digital fingerprint data structure 306, and generate the hash data structure 308 based at least in part on the aggregated digital fingerprint data structure 306. The data flow system 300 may further generate a real estate audit report for the real estate asset based at least in part on the aggregated digital fingerprint data structure 306 stored in the object-relational database 312 and cause a rendering of the real estate audit report via the dashboard visualization 314.

In some embodiments, the digital data associated with the digital fingerprint comprises AI decision data associated with one or more inputs utilized by an AI model to generate AI model output. In such embodiments, the output generated by the data flow system 300 comprises an AI decision log that provides an immutable record of the AI decision data. Because the data is stored on the application-specific distributed ledger 106 and anchored to the consensus layer 110, the records cannot be retroactively modified, thereby providing verifiable audit trails for AI model input and/or AI model output.

The data flow system 300 combines centralized components including the API endpoint 103, batch processing 302, and object-relational database 312 with decentralized components including the application-specific distributed ledger 106 and consensus layer 110 to provide secure, verifiable data storage with simplified integration through a standard REST API interface. This hybrid architecture enables the data flow system 300 to maintain high data throughput even during temporary outages of the distributed ledger components, as the centralized components may queue incoming fingerprints until the decentralized components become available. The data flow system 300 generates output associated with the digital fingerprint based at least in part on the hash data structure 308 added to the application-specific distributed ledger 106 and the aggregated digital fingerprint data structure 306 stored in the object-relational database 312, providing users with verification capabilities and visualization of fingerprint records through the dashboard visualization 314.

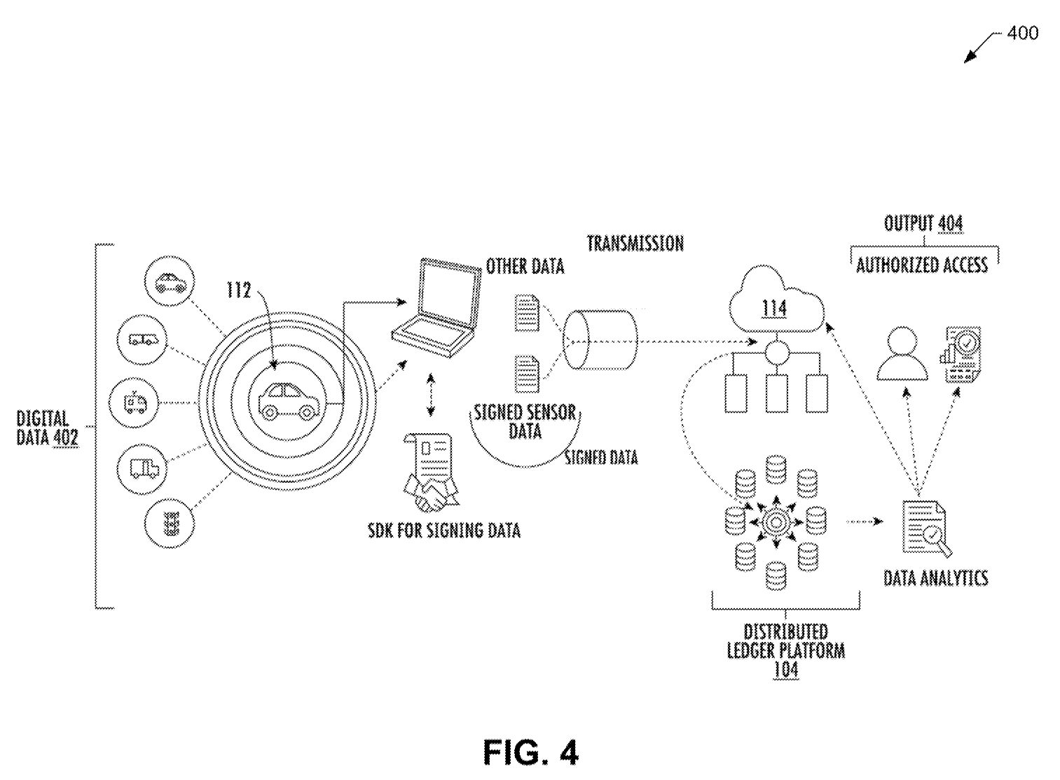

FIG. 4 illustrates a system 400 depicting a data flow architecture for secure data fingerprinting and immutable storage from disparate data sources in accordance with at least one example embodiment of the present disclosure. For example, the system 400 may illustrate the flow of digital data 402 from a client device 112 through a signing and transmission process to the network 114 and ultimately to output 404 including authorized access points, data analytics components, dashboard visualizations, and/or other output. In some embodiments, the system 400 represents an end-to-end architecture for capturing data at the source, cryptographically signing the data to ensure authenticity, transmitting the signed data through secure channels, validating and storing the data on a distributed network, and providing authorized access to the stored data for applications, reports, and analytics.

In some embodiments, the client device 112 is a vehicle, an aircraft, a camera, a mobile device, a sensor device (e.g., a sensor array), an industrial device, or another type of client device. Additionally, the client device 112 may be a data source from disparate data sources from which the digital data 402 may be captured and fingerprinted. In some embodiments, the client device 112 includes an Internet of Things (IoT) device, an edge computing device, and other data-generating equipment that generates the digital data 402. The digital data 402 may include sensor data, telemetry data, image data, document data, real estate property data, AI decision data, AI model output data, AI model input data, and/or other forms of digital data. In some embodiments, the client device 112 may generate the digital data 402 in response to a client device event such as, but not limited to, a sensor reading, a location update, a status change, or another occurrences that produces data where cryptographic verification and immutable storage is desirable.

In some embodiments, the system 400 includes a software development kit (SDK) for signing data that is configured to cryptographically sign data at or near the source. In some embodiments, the SDK uses a private key to sign data and appends a signature to the data payload. The SDK may operate with a signing service level agreement (SLA) of less than one millisecond, enabling real-time or near-real-time signing of data as it is generated by the source devices. By signing data as close to the source as possible, the system 400 ensures that the data has not been tampered with in transit or at rest. The SDK may be deployed on the source devices themselves, on middleware components, or on edge computing devices that are in communication with the source devices.

In some embodiments, the distributed ledger platform 104 may receive the signed digital data 402 and may execute a consensus algorithm to validate that the digital data 402 has come from an approved source, is of the correct format, and/or has not been tampered with. The distributed ledger platform 104 may also connect to multiple database storage elements arranged in a distributed configuration, enabling redundant storage and high availability of the stored data. Additionally, the distributed ledger platform 104 may process the digital data 402 as more fully disclosed herein to generate the output 404.

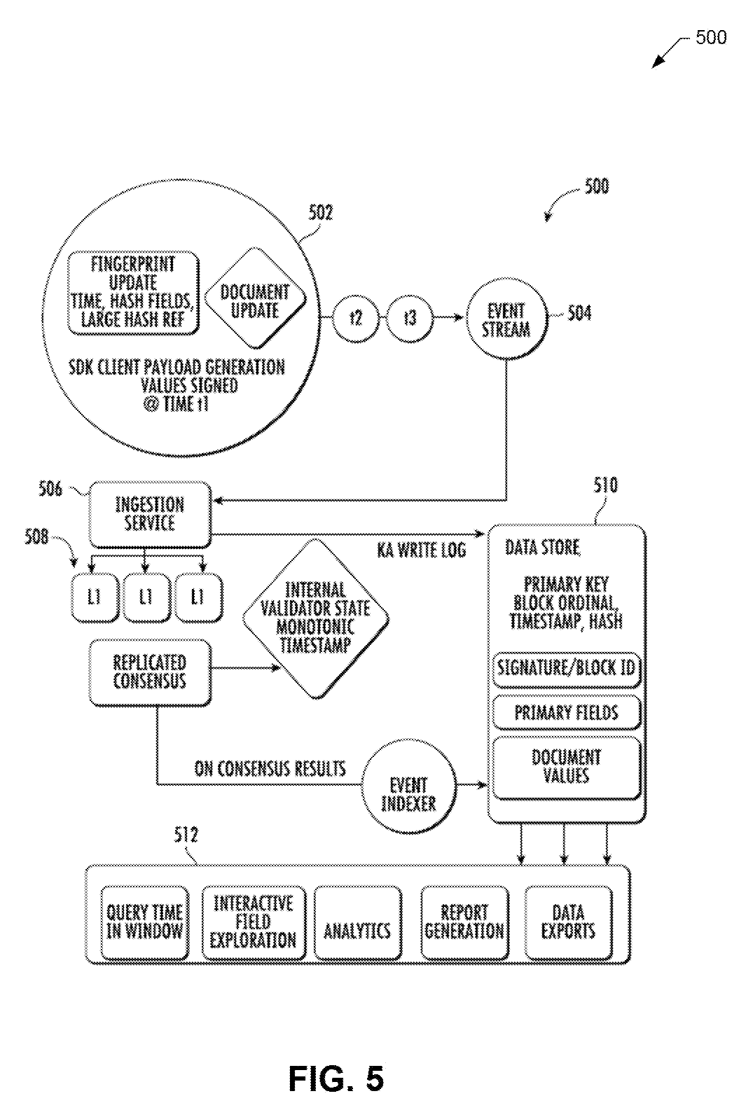

FIG. 5 illustrates a data flow architecture 500 for a digital evidence system in accordance with at least one example embodiment of the present disclosure. The data flow architecture 500 depicts the flow of data from client-side payload generation through ingestion, validation, consensus, storage, and visualization layers. In some embodiments, the data flow architecture 500 represents a comprehensive pipeline for processing digital fingerprints from initial generation through final storage and retrieval.

With the data flow architecture 500, an SDK client payload generation component 502 may sign data values at a particular time (e.g., at time t1). In some embodiments, the SDK client payload generation component 502 generates multiple data items per unique event or event batch. For example, a first data item may comprise a fingerprint update element including time, hash, fields, and/or hash reference information. The fingerprint update element may represent the on-chain data with fields embedded directly and used as validator functions. Additionally, a second data item may include a document update element that represents data too large or undesirable to fit onto the chain data, or data that is sensitive in nature. The on-chain data maintains a hash reference to the larger data, and both values may signed by a client device such as the client device 112. In some embodiments, the fingerprint update element and the document update element may be received via an event stream 504 that represents subsequent temporal processing stages in the pipeline. For example, the event stream 504 may include digital data associated with one or more client device events.

The data flow architecture 500 also includes an ingestion service component 506 that receives data from the event stream 504. In some embodiments, the ingestion service component 506 provides high availability for data ingestion operations. The ingestion service component 506 may also connects to one or more layer 1 (L1) nodes 508 that participate in replicated consensus operations. The L1 node(s) 508 may be responsible for ingesting data, performing initial validation, and/or reaching consensus using a consensus mechanism.

In some embodiments, the data flow architecture 500 utilizes internal validator state functionality to maintain monotonic timestamp information. In some embodiments, the internal validator state functionality validates that a timestamp associated with each digital fingerprint is greater than a previously recorded timestamp associated with a client identifier, thereby preventing replay of previously submitted digital fingerprints. The internal validator state functionality may also communicates with the L1 nodes and the replicated consensus component to ensure that valid data with properly ordered timestamps is accepted for storage.

A write log pathway may also extends from the ingestion service to a data store 510. In some embodiments, the write log pathway provides a mechanism for writing data to the storage layer. The data store 510 may include a primary key, timestamp, and/or hash information. For example, the data store 510 may include a signature and block ID field, one or more primary fields, and/or document values. In some embodiments, the data store 510 corresponds to an object-relational database such as the object-relational database 108 that maintains fingerprint data including metadata fields, signatures, and/or references to associated digital data.

Additionally, a dashboard visualization component 512 may provide various visualization and/or analytic capabilities. In some embodiments, the dashboard visualization component 512 includes query time in window functionality that enables users to search for fingerprints within specified time ranges. The dashboard visualization component 512 may further include interactive field exploration that allows users to examine and filter fingerprint data based on various metadata fields. Additionally, the dashboard visualization component 512 may provide analytics for reporting, report generation for creating customized audit reports, and/or data exports for extracting fingerprint data for use in external systems. The dashboard visualization component 512 may also receive data from the data store 510 to enable the visualization and reporting functionality, providing authorized users with comprehensive access to the stored digital fingerprint data.

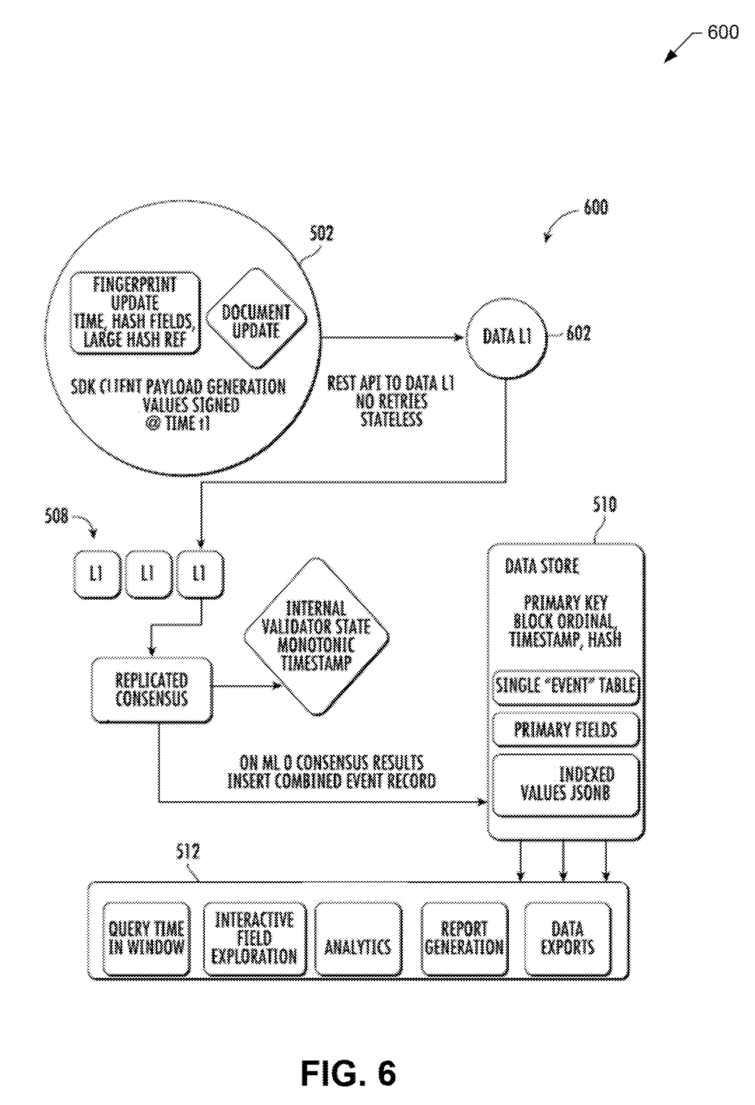

FIG. 6 illustrates a data flow architecture 600 depicting an alternative architecture and data processing pipeline for a digital evidence system in accordance with at least one example embodiment of the present disclosure. In contrast to the data flow architecture 500 of FIG. 5 which utilizes an event stream and ingestion service, the data flow architecture 600 illustrates the SDK client payload generation component 502 transmitting digital data 602 via an API (e.g., a REST API) directly to one or more data L1 nodes. In some embodiments, the API transmission is stateless and includes no retry mechanisms. This stateless approach simplifies the client-side implementation by eliminating the need for the client to maintain connection state or implement retry logic, as the monotonic timestamp validation at the L1 nodes is sufficient to ensure data integrity and prevent replay attacks.

In some embodiments, upon achieving consensus results, an INSERT operation may be performed for combined event records into the data store 510. For example, the combined event record may include the fingerprint update data and the document update data as a unified record. The data store 510 may also include a single event table structure with primary fields and large indexed values stored in a defined format such as a JSON format. This single event table approach differs from architectures that maintain separate tables for different data types, providing a simplified storage schema that consolidates fingerprint and document data within a unified table structure.

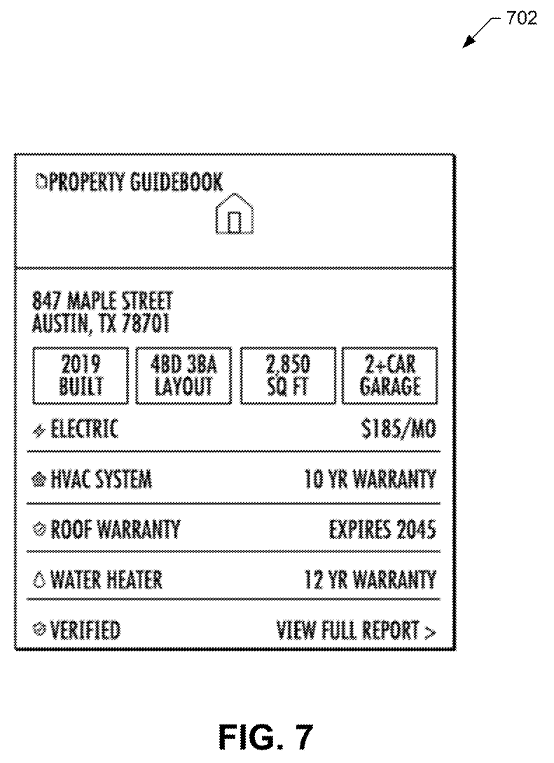

FIG. 7 illustrates an example electronic interface 702 in accordance with at least one example embodiment of the present disclosure. For example, the electronic interface 702 may depict a property guidebook interface for a real estate property. The electronic interface 702 may be a user interface, a web user interface, an application user interface, or another type of electronic interface for a display of a client device. Additionally, the electronic interface 702 may include one or more interactive user interface elements. In some embodiments, the electronic interface 702 represents a dashboard visualization that displays verified real estate property data retrieved from the object-relational database 108 and validated against the application-specific distributed ledger 106 (e.g., the application-specific distributed ledger 106). In some embodiments, the electronic interface 702 provides a comprehensive view of property information, attributes, and/or warranty details that have been fingerprinted and immutably stored using the distributed ledger platform 104 disclosed herein.

As an example, the electronic interface 702 displays a house icon at the top followed by a property address, which in the illustrated embodiment is 847 Maple Street, Austin, TX 78701. Below the property address, the electronic interface 702 presents a row of property attributes including the year built (2019), the layout (4 bedrooms and 3 bathrooms), the square footage (2,850), and the garage capacity (2-car). In some embodiments, each of these property attributes is associated with a digital fingerprint that has been aggregated into an aggregated digital fingerprint data structure and stored in the object-relational database 108, with a corresponding hash data structure added to the application-specific distributed ledger 106 to provide immutable verification of the property attribute data.

The electronic interface 702 further displays a list of property-related information including utility costs and warranty details. In the illustrated embodiment, the property-related information includes an electric utility cost of $185 per month, an HVAC system with a 10 year warranty, a roof warranty that expires in 2045, and a water heater with a 12 year warranty. In some embodiments, each item of property-related information is associated with one or more digital fingerprints that provide a verifiable chain of custody for the underlying documentation, such as utility bills, warranty certificates, and installation records. The digital fingerprints enable verification that the property-related information has not been altered since it was originally fingerprinted and stored on the distributed ledger platform 104.

Additionally, a verified indicator appears alongside a link to view the full report via the electronic interface 702. In some embodiments, the verified indicator signifies that the property data displayed in the electronic interface 702 has been validated against the hash data structure stored on the application-specific distributed ledger 106, confirming that the data has not been tampered with since it was originally submitted. The link to view the full report enables users to access a comprehensive real estate audit report that includes additional details, documentation, and verification information associated with the property.

The electronic interface 702 demonstrates a domain-specific application of the distributed ledger platform 104 for real estate property documentation. However, it is to be appreciated that the electronic interface 702 may be configured for a different type of asset or dashboard visualization. In some embodiments, the electronic interface 702 is rendered based at least in part on the hash data structure added to the application-specific distributed ledger 106 and the aggregated digital fingerprint data structure stored in the object-relational database 108. By combining data from both the application-specific distributed ledger 106 and the object-relational database, which provides complete fingerprint data and efficient querying, the electronic interface 702 presents users with a trusted and verifiable record of property information that can be used for insurance underwriting, property sales, rental management, compliance verification, and other real estate-related use cases.

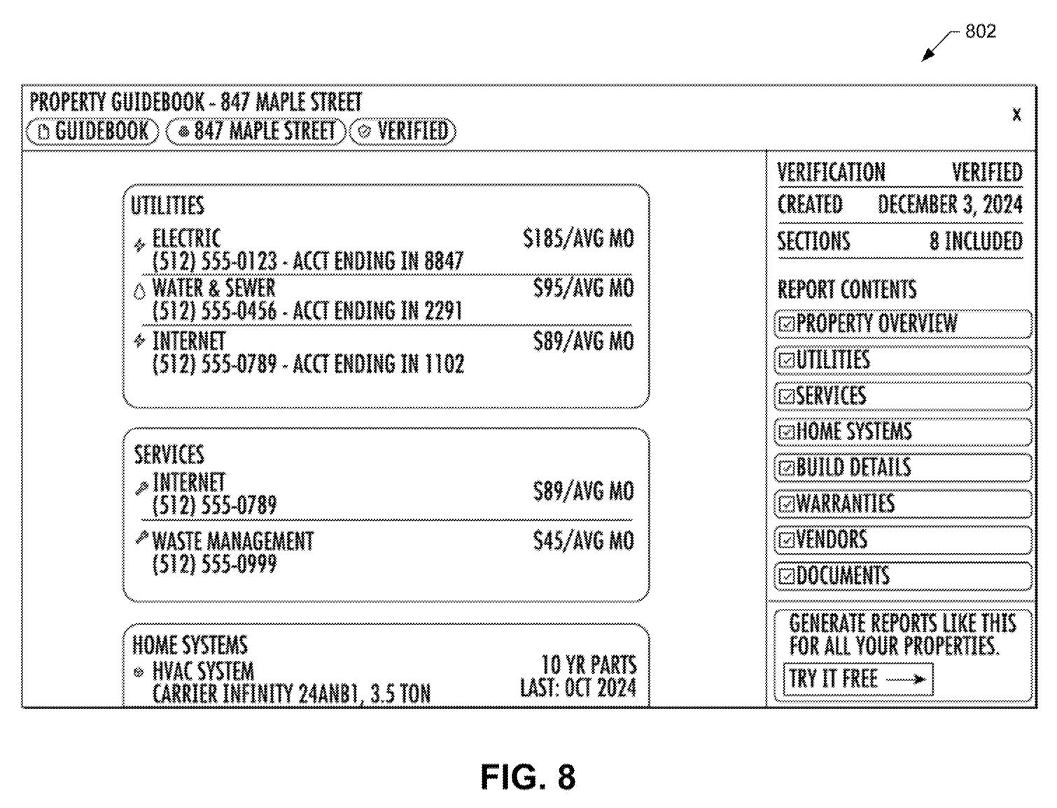

FIG. 8 illustrates an example electronic interface 802 in accordance with at least one example embodiment of the present disclosure. For example, the electronic interface 802 may depict a detailed property guidebook interface for a real estate property that provides additional information beyond the electronic interface 702 of FIG. 7. The electronic interface 802 may be a user interface, a web user interface, an application user interface, or another type of electronic interface for a display of a client device. Additionally, the electronic interface 802 may include one or more interactive user interface elements. In some embodiments, the electronic interface 802 represents a dashboard visualization that displays a verification status indicator, a creation date, and a section count indicating the comprehensiveness of the property report. In the illustrated embodiment, the electronic interface 802 displays the property data as verified, along with a creation date of Dec. 3, 2024, and an indication that 8 sections are included in the report.

The electronic interface 802 also presents a utilities section that lists utility service information associated with the real estate property. In the illustrated embodiment, the utilities section includes electric service with a phone number and account ending digits along with an average monthly cost of $185, water and sewer service with a phone number and account ending digits along with an average monthly cost of $95, and internet service with a phone number and account ending digits along with an average monthly cost of $89. In some embodiments, each utility service entry is associated with a digital fingerprint that has been aggregated into an aggregated digital fingerprint data structure and stored in the object-relational database 108, with a corresponding hash data structure added to the application-specific distributed ledger 106 to provide immutable verification of the utility service data.

The electronic interface 802 further displays a services section that lists service provider information associated with the real estate property. In the illustrated embodiment, the services section includes internet service provided by Spectrum with a phone number and an average monthly cost of $89, as well as waste management service with a phone number and an average monthly cost of $45. In some embodiments, each service provider entry is associated with one or more digital fingerprints that provide a verifiable chain of custody for the underlying service agreements and billing records.

The electronic interface 802 additionally displays a home systems section that provides detailed information about installed systems within the real estate property. In the illustrated embodiment, the home systems section shows an HVAC system identified as a Carrier Infinity 24ANB1 with a 3.5 ton capacity, a 10 year parts warranty, and a last service date of October 2024. In some embodiments, the home systems information is associated with digital fingerprints that enable verification of system specifications, warranty documentation, and maintenance records. The digital fingerprints enable verification that the home systems information has not been altered since it was originally fingerprinted and stored on the distributed ledger platform 104.

The electronic interface 802 also includes a report contents panel displayed on the right side of the interface. In the illustrated embodiment, the report contents panel displays checkboxes indicating included sections comprising property overview, utilities, services, home systems, build details, warranties, vendors, and documents. In some embodiments, each section corresponds to a category of digital fingerprints that have been aggregated and stored in the object-relational database 108. The report contents panel enables users to navigate between different sections of the property guidebook and view the associated verified data for each category.

Additionally, a promotional element appears at the bottom of the report contents panel via the electronic interface 802. In the illustrated embodiment, the promotional element invites users to generate reports for all their properties with a button to try the service for free. In some embodiments, the promotional element enables users to extend the distributed ledger platform 104 functionality to additional real estate properties, thereby creating a portfolio of verified property records that can be used for property management, insurance underwriting, and compliance verification purposes.

The electronic interface 802 demonstrates the comprehensive property documentation capabilities of the distributed ledger platform 104 for real estate applications. In some embodiments, the electronic interface 802 is rendered based at least in part on the hash data structure added to the application-specific distributed ledger 106 and the aggregated digital fingerprint data structure stored in the object-relational database 108. By combining data from both the application-specific distributed ledger 106, which provides immutability guarantees and verification capabilities, and the object-relational database 108, which provides complete fingerprint data and efficient querying, the electronic interface 802 presents users with a trusted and verifiable record of detailed property information including utilities, services, home systems, and documentation that supports property management, real estate transactions, and regulatory compliance use cases.

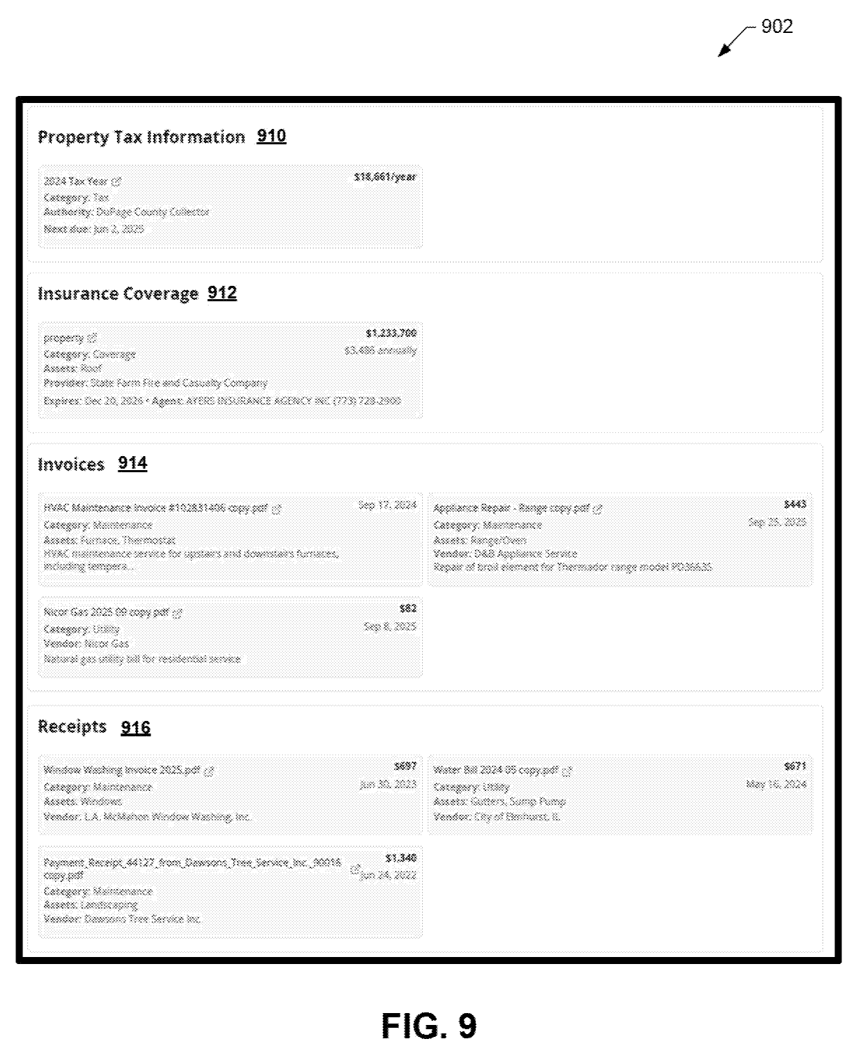

FIG. 9 illustrates an example electronic interface 902 in accordance with at least one example embodiment of the present disclosure. For example, the electronic interface 902 may depict a detailed property guidebook interface for a real estate property that provides additional information beyond the electronic interface 702 of FIG. 7 and/or the electronic interface 802 of FIG. 8. The electronic interface 902 may be a user interface, a web user interface, an application user interface, or another type of electronic interface for a display of a client device. Additionally, the electronic interface 902 may include one or more interactive user interface elements.

In some embodiments, the electronic interface 902 is rendered via interaction with the electronic interface 802, such as by selecting a section or navigation element within the electronic interface 802. The electronic interface 902 represents a dashboard visualization that displays property tax information, insurance coverage, invoices, and receipts associated with the real estate property, each of which may be associated with one or more digital fingerprints that have been aggregated and stored on the distributed ledger platform 104.

In some embodiments, the electronic interface 902 includes a Property Tax Information section 910 that displays tax-related data associated with the real estate property. In the illustrated embodiment, the Property Tax Information section 910 displays a 2024 Tax Year entry with a cost of $18,661 per year, a category designation of Tax, an authority identified as DuPage County Collector, and a next due date of Jun. 2, 2025. However, it is to be appreciated that the content illustrated in FIG. 9 for the Property Tax Information section 910 is a non-limiting example illustrated for exemplary purposes. In some embodiments, the property tax information is associated with a digital fingerprint that has been aggregated into an aggregated digital fingerprint data structure and stored in the object-relational database 108, with a corresponding hash data structure added to the application-specific distributed ledger 106 to provide immutable verification of the tax record data.

In some embodiments, the electronic interface 902 includes an Insurance Coverage section 912 that displays insurance policy information associated with the real estate property. In the illustrated embodiment, the Insurance Coverage section 912 displays a property entry with a coverage amount of $1,233,700 and an annual premium of $3,486. The Insurance Coverage section further identifies the category as Coverage, the assets as Roof, the provider as State Farm Fire and Casualty Company, an expiration date of Dec. 20, 2026, and an agent identified as AYERS INSURANCE AGENCY INC with a phone number. However, it is to be appreciated that the content illustrated in FIG. 9 for the Insurance Coverage section 912 is a non-limiting example illustrated for exemplary purposes. In some embodiments, the insurance coverage information is associated with one or more digital fingerprints that provide a verifiable chain of custody for the underlying insurance policy documentation, enabling verification that the coverage details have not been altered since originally fingerprinted.

In some embodiments, the electronic interface 902 includes an Invoices section 914 that displays multiple invoice entries associated with the real estate property. In the illustrated embodiment, the Invoices section 914 includes a first invoice entry showing an HVAC Maintenance Invoice dated Sep. 17, 2024, with a category of Maintenance, assets identified as Furnace and Thermostat, and a description indicating HVAC maintenance service for upstairs and downstairs furnaces including temperature-related work. A second invoice entry shows an Appliance Repair for a Range with a cost of $443 dated Sep. 25, 2025, with a category of Maintenance, assets identified as Range/Oven, a vendor identified as D&B Appliance Service, and a description indicating repair of a broil element for a Thermador range. A third invoice entry shows a Nicor Gas utility bill with a cost of $82 dated Sep. 8, 2025, with a category of Utility, a vendor identified as Nicor Gas, and a description indicating natural gas utility service for residential service. However, it is to be appreciated that the content illustrated in FIG. 9 for the Invoices section 914 is a non-limiting example illustrated for exemplary purposes. In some embodiments, each invoice entry is associated with a digital fingerprint that enables verification of the invoice details and provides an immutable record of property maintenance and utility expenses.

In some embodiments, the electronic interface 902 includes a Receipts section 916 that displays multiple receipt entries associated with the real estate property. In the illustrated embodiment, the Receipts section 916 includes a first receipt entry showing a Window Washing Invoice with a cost of $697 dated Jun. 30, 2023, with a category of Maintenance, assets identified as Windows, and a vendor identified as L.A. McMahon Window Washing, Inc. A second receipt entry shows a Water Bill with a cost of $671 dated May. 16, 2024, with a category of Utility, assets identified as Gutters and Sump Pump, and a vendor identified as City of Elmhurst, IL. A third receipt entry shows a Tree Service payment receipt with a cost of $1,340 dated Jun. 24, 2022, with a category of Maintenance, assets identified as Landscaping, and a vendor identified as Dawsons Tree Service Inc. However, it is to be appreciated that the content illustrated in FIG. 9 for the Receipts section 916 is a non-limiting example illustrated for exemplary purposes. In some embodiments, each receipt entry is associated with one or more digital fingerprints that provide a verifiable chain of custody for the underlying payment documentation.

The electronic interface 902 demonstrates the comprehensive financial and maintenance documentation capabilities of the distributed ledger platform 104 for real estate applications. In some embodiments, the electronic interface 902 is rendered based at least in part on the hash data structure added to the application-specific distributed ledger 106 and the aggregated digital fingerprint data structure stored in the object-relational database 108. Each entry displayed in the electronic interface 902, including property tax records, insurance coverage details, invoices, and receipts, may be associated with a digital fingerprint that has been aggregated into an aggregated digital fingerprint data structure and stored in the object-relational database 108, with a corresponding hash data structure added to the application-specific distributed ledger 106 to provide immutable verification of the property financial records. By combining data from both the application-specific distributed ledger 106, which provides immutability guarantees and verification capabilities, and the object-relational database 108, which provides complete fingerprint data and efficient querying, the electronic interface 902 presents users with a trusted and verifiable record of property financial information that supports property management, insurance claims, tax documentation, and/or regulatory compliance use cases.

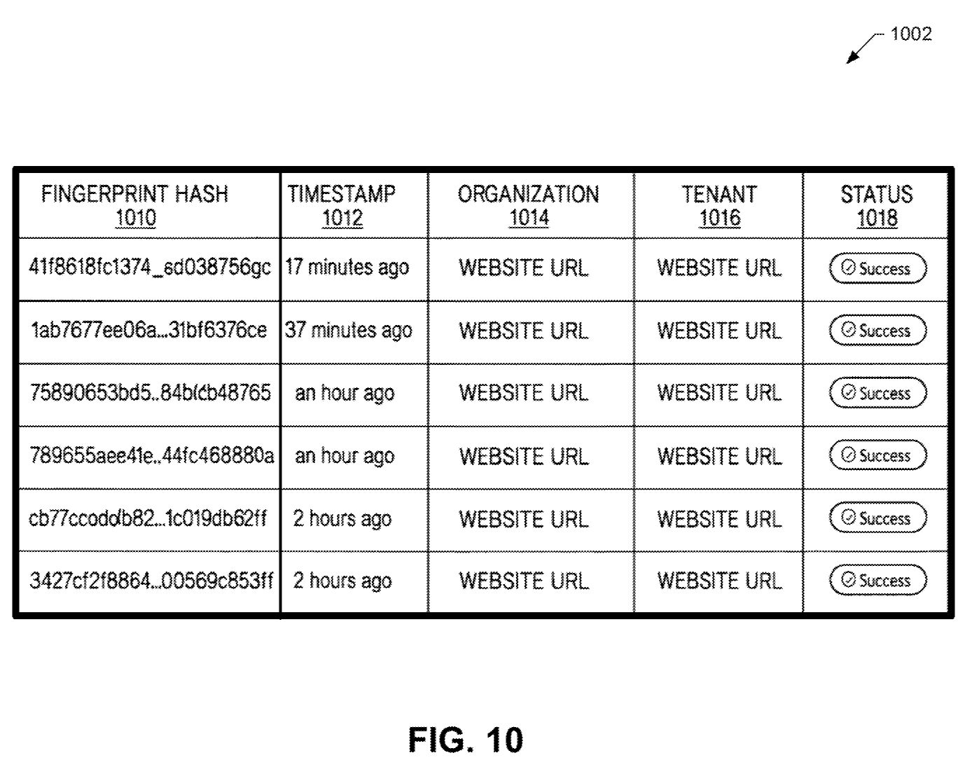

FIG. 10 illustrates an example electronic interface 1002 in accordance with at least one example embodiment of the present disclosure. For example, the electronic interface 1002 may depict a dashboard visualization for digital fingerprint records. In some embodiments, the electronic interface 1002 represents a dashboard visualization that displays digital fingerprint records in a table structure, enabling users to view recent fingerprint submissions and access information about individual fingerprints stored on the distributed ledger platform 104.

The electronic interface 1002 presents a table structure with multiple columns including a fingerprint hash column 1010, a timestamp column 1012, an organization column 1014, a tenant column 1016, and a status column 1018. In some embodiments, each row in the table corresponds to a digital fingerprint that has been aggregated into an aggregated digital fingerprint data structure and stored in the object-relational database 108, with a corresponding hash data structure added to the application-specific distributed ledger 106 to provide immutable verification of the fingerprint data.

The fingerprint hash column 1010 displays truncated hash values for each fingerprint record. In some embodiments, each hash value represents a cryptographic hash of the digital fingerprint content, enabling verification of data integrity against the hash data structure stored on the application-specific distributed ledger 106. In the illustrated embodiment, the fingerprint hash column 1010 includes entries such as a first fingerprint hash (e.g., 41f8618c15374...9d0387569c7707), a second fingerprint hash (e.g., 1ab7677ee0a6f...31b6f376ce4941a), a third fingerprint hash (e.g., 75890853bd5...9a81462db487653), a fourth fingerprint hash (e.g., 789ef5ae7e41f...bfbe48cfa588a0a), a fifth fingerprint hash (e.g., 5acba0e6ca2d...74eae303dc76a0), a sixth fingerprint hash (e.g., cb7c7cc0dbf82...1c01091b612eb8ff), and a seventh fingerprint hash (e.g., 3427cf2f8864...005b3063b35ff0).

The timestamp column 1012 displays relative time indicators showing when each fingerprint was submitted. In the illustrated embodiment, the timestamp column 1012 includes entries of 17 minutes ago, 37 minutes ago, an hour ago, an hour ago, 2 hours ago, 2 hours ago, and 2 hours ago. In some embodiments, the timestamp information enables users to identify recent fingerprint submissions and track the chronological order of fingerprint activity within the distributed ledger platform 104.

The organization column 1014 and the tenant column 1016 display identifiers associated with each fingerprint record. In some embodiments, the organization and tenant identifiers enable access control and filtering of fingerprint records based on account-level authentication and authorization policies.

The status column 1018 displays verification status indicators for each fingerprint record. In the illustrated embodiment, all entries in the status column 1018 show a Success status accompanied by a checkmark icon, indicating that the corresponding digital fingerprints have been successfully validated and stored on the application-specific distributed ledger 106. In some embodiments, the status indicators signify that the fingerprint data has been validated against the hash data structure stored on the application-specific distributed ledger 106, confirming that the data has been successfully committed to the distributed ledger with immutability guarantees. However, it is to be appreciated that the content illustrated in FIG. 10 is a non-limiting example illustrated for exemplary purposes.

In some embodiments, the electronic interface 1002 is rendered based at least in part on the hash data structure added to the application-specific distributed ledger 106 and the aggregated digital fingerprint data structure stored in the object-relational database 108. By combining data from both the application-specific distributed ledger 106, which provides immutability guarantees and verification capabilities, and the object-relational database 108, which provides complete fingerprint data and efficient querying, the electronic interface 1002 presents users with a comprehensive view of fingerprint activity that supports monitoring, auditing, and verification of digital fingerprint records stored on the distributed ledger platform 104.

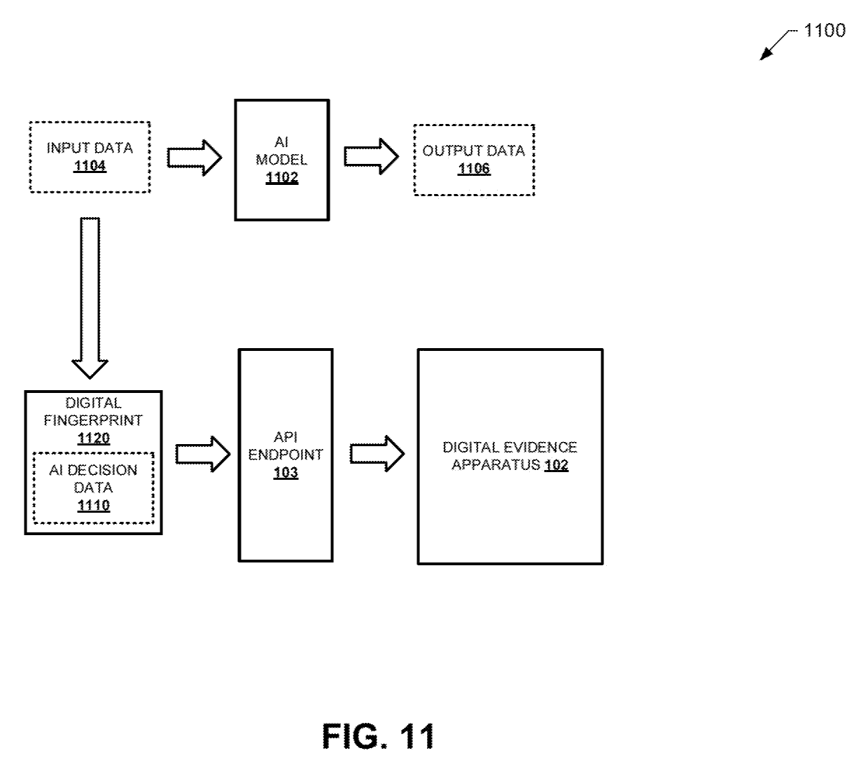

FIG. 11 illustrates an example data flow system 1100 for secure for secure data fingerprinting and immutable storage of AI decision data in accordance with at least one example embodiment of the present disclosure. The data flow system 1100 depicts the flow of data from an AI model 1102 through a digital fingerprinting process to a digital evidence apparatus 102 for immutable storage on a distributed ledger. In some embodiments, the data flow system 1100 enables documentation of AI decision-making by providing an immutable record of the inputs, outputs, and/or logic used for AI modeling.

The data flow system 1100 includes input data 1104 that is provided to the AI model 1102. The input data 1104 represents the data utilized by the AI model 1102 to generate predictions, decisions, and/or other computational outputs. In some embodiments, the input data 1104 may comprise prompts, queries, sensor data, user inputs, a feature set, or other information that serves as the basis for AI model processing. The AI model 1102 may process the input data 1104 to generate output data 1106. The output data 1106 represents the results produced by the AI model 1102 based on the processing of the input data 1104. In some embodiments, the output data 1106 may comprise predictions, classifications, recommendations, generated content, and/or other machine learning results produced by the AI model 1102.

The data flow system 1100 further includes AI decision data 1110 that is associated with the input data 1104 and captures information related to the inputs utilized by the AI model 1102 to generate the output data 1106. In some embodiments, the AI decision data 1110 comprises a record of the decision-making process including the input data 1104, model parameters, decision logic, prompts, and/or resulting outputs. The AI decision data 1110 provides the basis for creating verifiable audit trails of automated decisions.

The data flow system 1100 also includes a digital fingerprint 1120 that comprises the AI decision data 1110. For example, the digital fingerprint 1120 may be a cryptographic representation of the AI decision data 1110 that enables verification of data integrity and provides an immutable record of the AI decision process. In some embodiments, the digital fingerprint 1120 includes a cryptographic hash of the AI decision data 1110 along with associated metadata such as a timestamp, an entity identifier, an organization identifier, a tenant identifier, and/or a signer identifier comprising a public key. The digital fingerprint 1120 also enables verification that the AI decision data 1110 has not been altered since it was originally fingerprinted.

In some embodiments, the digital fingerprint 1120 may be transmitted to the API endpoint 103 via an API data structure. For instance, the API endpoint 103 may receive the digital fingerprint 1120 via an API data structure that comprises the digital fingerprint 1120. Additionally, the API endpoint 103 may initiate processing within the digital evidence apparatus 102. In some embodiments, the digital evidence apparatus 102 processes the digital fingerprint 1120 by aggregating the digital fingerprint 1120 with other digital fingerprints, generating a hash data structure, and adding the hash data structure to the application-specific distributed ledger 106 for immutable storage of the AI decision data 1110.

In some embodiments, an output generated by the digital evidence apparatus 102 comprises an AI decision log that provides an immutable record of the AI decision data 1110. Because the AI decision data 1110 is stored on the application-specific distributed ledger 106 and anchored to the consensus layer 110, the AI decision data 1110 cannot be retroactively modified, thereby providing verifiable audit trails for the input data 1104 and/or the output data 1106 associated with the AI model 1102.

As such, the data flow system 1100 may enable the creation of verifiable audit trails for AI model decisions by fingerprinting the AI decision data 1110 and storing the corresponding digital fingerprint on a distributed ledger through the digital evidence apparatus 102. By storing the AI decision data 1110 on a public distributed ledger with decentralized consensus, the data flow system 1100 also provides trust guarantees where no single entity can unilaterally modify historical records of AI decisions.

In some embodiments, the data flow system 1100 may be configured to process AI decision data 1110 in real-time or near real-time as the AI model 1102 processes input data 1104 and generates output data 1106. This real-time fingerprinting capability enables continuous documentation of AI decision-making processes, providing a comprehensive audit trail that captures the temporal sequence of AI model operations. The digital evidence apparatus 102 may also aggregate multiple digital fingerprints associated with AI decision data 1110 into an aggregated digital fingerprint data structure using a hierarchical tree structure, enabling efficient storage of large volumes of AI decision records while maintaining the ability to verify individual decisions against the hash data structure stored on the application-specific distributed ledger 106.

Having described example systems and apparatuses, related data flows, and user interfaces in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depict a particular sequence of operations, the sequence can be altered without departing from the scope of the present disclosure. For example, some of the operations depicted can be performed in parallel or in a different sequence that does not materially affect the function of the processes.

The blocks indicate operations of each process. Such operations can be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart can be combinable, replaceable, and/or otherwise altered as described herein.

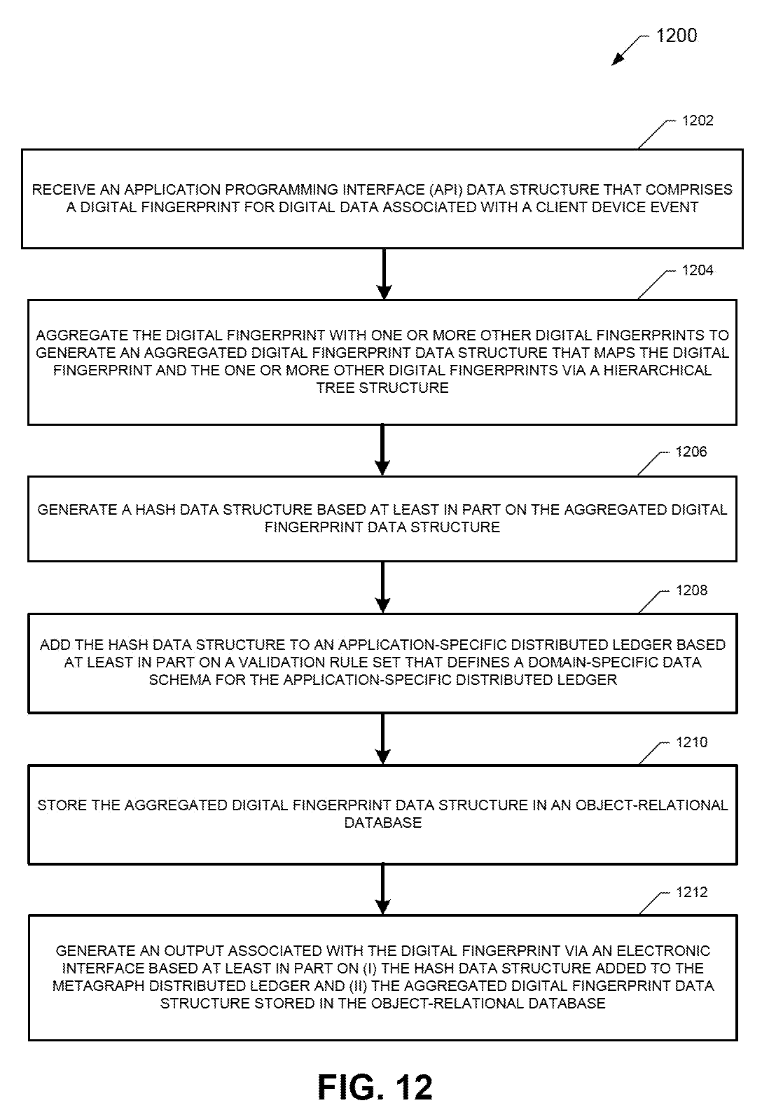

FIG. 12 illustrates a process 1200 depicting example operations for providing secure data fingerprinting and immutable data storage using an application-specific distributed ledger. The process 1200 embodies an example computer-implemented method. In some embodiments, the process 1200 is embodied by computer program code stored on a non-transitory computer-readable storage medium of a computer program product configured for execution to perform the process as depicted and described. Alternatively or additionally, in some embodiments, the process 1200 is performed by one or more specially configured computing devices, such as the digital evidence apparatus 102 alone or in communication with one or more other component(s), device(s), system(s), and/or the like. In this regard, in some such embodiments, the digital evidence apparatus 102 is specially configured by computer-coded instructions (e.g., computer program instructions) stored thereon, for example in the memory 204 and/or another component depicted and/or described herein and/or otherwise accessible to the digital evidence apparatus 102, for performing the operations as depicted and described. In some embodiments, the digital evidence apparatus 102 is in communication with one or more external apparatus(es), system(s), device(s), and/or the like, to perform one or more of the operations as depicted and described. For example, the digital evidence apparatus 102 in some embodiments is in communication with a separate primary system, client system, and/or the like. For purposes of simplifying the description, the process 1200 is described as performed by and from the perspective of the digital evidence apparatus 102.

According to some examples, the process 1200 includes receiving an application programming interface (API) data structure that comprises a digital fingerprint for digital data associated with a client device event, at block 1202.

According to some examples, the process 1200 includes aggregating the digital fingerprint with one or more other digital fingerprints to generate an aggregated digital fingerprint data structure that maps the digital fingerprint and the one or more other digital fingerprints via a hierarchical tree structure, at block 1204.

According to some examples, the process 1200 includes generating a hash data structure based at least in part on the aggregated digital fingerprint data structure, at block 1206.

According to some examples, the process 1200 includes adding the hash data structure to an application-specific distributed ledger based at least in part on a validation rule set that defines a domain-specific data schema for the application-specific distributed ledger, at block 1208.

According to some examples, the process 1200 includes storing the aggregated digital fingerprint data structure in an object-relational database, at block 1210.

According to some examples, the process 1200 includes generating an output associated with the digital fingerprint based at least in part on (i) the hash data structure added to the application-specific distributed ledger and (ii) the aggregated digital fingerprint data structure stored in the object-relational database, at block 1212.

Although the process 1200 depicts a particular sequence of operations, the sequence may be altered without departing from the scope of the present disclosure. For example, some of the operations depicted may be performed in parallel or in a different sequence that does not materially affect the function of the processes. Additionally, such operations may be performed in any of a number of ways, including, without limitation, in the order and manner as depicted and described herein. In some examples, the process 1200 includes some or all operations described and/or depicted. Similarly, it should be appreciated that one or more of the operations of the process 1200 may be combinable, replaceable, and/or otherwise altered as described herein.

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics of certain example embodiments will be highlighted in a set of numbered clauses or paragraphs. These characteristics are not to be interpreted as being limiting on the invention or inventive concept, but are provided merely as a recitation of some characteristics as described herein, without suggesting a particular order of importance or relevancy of such example characteristics.

Clause 1. An apparatus comprising one or more processors and one or more storage devices storing instructions that are operable, when executed by the one or more processors, to cause the one or more processors to: receive an application programming interface (API) data structure that comprises a digital fingerprint for digital data associated with a client device event; aggregate the digital fingerprint with one or more other digital fingerprints to generate an aggregated digital fingerprint data structure that maps the digital fingerprint and the one or more other digital fingerprints via a hierarchical tree structure; generate a hash data structure based at least in part on the aggregated digital fingerprint data structure; add the hash data structure to an application-specific distributed ledger based at least in part on a validation rule set that defines a domain-specific data schema for the application-specific distributed ledger; store the aggregated digital fingerprint data structure in an object-relational database; and generate an output associated with the digital fingerprint based at least in part on (i) the hash data structure added to the application-specific distributed ledger and (ii) the aggregated digital fingerprint data structure stored in the object-relational database.

Clause 2. The apparatus of Clause 1, wherein the digital fingerprint comprises a cryptographic hash of the digital data.

Clause 3. The apparatus of Clause 2, wherein the digital fingerprint further comprises at least one of a timestamp and an entity identifier.

Clause 4. The apparatus of any of the aforementioned Clauses, wherein the hierarchical tree structure comprises a Merkle tree that maps the digital fingerprint and the one or more other digital fingerprints to a cryptographic hash.

Clause 5. The apparatus of any of the aforementioned Clauses, wherein the instructions are further operable to cause the one or more processors to: based at least in part on the hash data structure being added to the application-specific distributed ledger, transmit at least a portion of the hash data structure to a consensus layer that connects the application-specific distributed ledger to one or more other distributed ledgers.

Clause 6. The apparatus of any of the aforementioned Clauses, wherein the instructions are further operable to cause the one or more processors to: cause a rendering of a dashboard visualization associated with the digital fingerprint via an electronic interface based at least in part on (i) the hash data structure added to the application-specific distributed ledger and (ii) the aggregated digital fingerprint data structure stored in the object-relational database.

Clause 7. The apparatus of Clause 6, wherein the instructions are further operable to cause the one or more processors to: receive a search query via a search API; retrieve the digital fingerprint from the object-relational database based at least in part on the search query; and cause the rendering of the dashboard visualization based at least in part on the search query.

Clause 8. The apparatus of any of the aforementioned Clauses, wherein the instructions are further operable to cause the one or more processors to: receive a document data structure associated with the digital fingerprint; verify that a first hash of the document data structure matches a second hash of the digital fingerprint; correlate the document data structure with the aggregated digital fingerprint data structure stored in the object-relational database; and generate the output based at least in part on (i) the hash data structure added to the application-specific distributed ledger, (ii) the aggregated digital fingerprint data structure stored in the object-relational database, and (iii) the document data structure.

Clause 9. The apparatus of any of the aforementioned Clauses, wherein the digital fingerprint is a first digital fingerprint, the digital data is first digital data, and the instructions are further operable to cause the one or more processors to: receive a second digital fingerprint for second digital data associated with the client device; aggregate the first digital fingerprint and the second digital fingerprint to generate the aggregated digital fingerprint data structure; generate the hash data structure based at least in part on the aggregated digital fingerprint data structure.

Clause 10. The apparatus of any of the aforementioned Clauses, wherein the digital data associated with the digital fingerprint comprises real estate property data associated with one or more real estate asset events.

Clause 11. The apparatus of Clause 10, wherein the output comprises a dashboard visualization that displays a chronological record of digital fingerprints associated with the real estate property data.

Clause 12. The apparatus of any of the aforementioned Clauses, wherein the digital fingerprint is a first digital fingerprint, the digital data comprises a first image associated with a real estate asset, and the instructions are further operable to cause the one or more processors to: receive a second digital fingerprint for a second image associated with the real estate asset; aggregate the first digital fingerprint and the second digital fingerprint to generate the aggregated digital fingerprint data structure; generate the hash data structure based at least in part on the aggregated digital fingerprint data structure.

Clause 13. The apparatus of Clause 12, wherein the instructions are further operable to cause the one or more processors to: generate a real estate audit report for the real estate asset based at least in part on the aggregated digital fingerprint data structure stored in the object-relational database; and cause a rendering of the real estate audit report via a dashboard visualization.

Clause 14. The apparatus of any of the aforementioned Clauses, wherein the digital data comprises artificial intelligence (AI) decision data associated with one or more inputs utilized by an AI model to generate AI model output, and wherein the output comprises an AI decision log that provides an immutable record of the AI decision data.

Clause 15. A computer-implemented method, comprising: receiving an application programming interface (API) data structure that comprises a digital fingerprint for digital data associated with a client device event; aggregating the digital fingerprint with one or more other digital fingerprints to generate an aggregated digital fingerprint data structure that maps the digital fingerprint and the one or more other digital fingerprints via a hierarchical tree structure; generating a hash data structure based at least in part on the aggregated digital fingerprint data structure; adding the hash data structure to an application-specific distributed ledger based at least in part on a validation rule set that defines a domain-specific data schema for the application-specific distributed ledger; storing the aggregated digital fingerprint data structure in an object-relational database; and generating an output associated with the digital fingerprint based at least in part on (i) the hash data structure added to the application-specific distributed ledger and (ii) the aggregated digital fingerprint data structure stored in the object-relational database.

Clause 16. The computer-implemented method of Clause 15, further comprising: based at least in part on the hash data structure being added to the application-specific distributed ledger, transmitting at least a portion of the hash data structure to a consensus layer that connects the application-specific distributed ledger to one or more other distributed ledgers.

Clause 17. The computer-implemented method of any of Clauses 15 or 16, further comprising: causing a rendering of a dashboard visualization associated with the digital fingerprint via an electronic interface based at least in part on (i) the hash data structure added to the application-specific distributed ledger and (ii) the aggregated digital fingerprint data structure stored in the object-relational database.

Clause 18. The computer-implemented method of Clause 17, further comprising: receiving a search query via a search API; retrieving the digital fingerprint from the object-relational database based at least in part on the search query; and causing the rendering of the dashboard visualization based at least in part on the search query.

Clause 19. The computer-implemented method of any of Clauses 15 to 18, further comprising: receiving a document data structure associated with the digital fingerprint; verifying that a first hash of the document data structure matches a second hash of the digital fingerprint; correlating the document data structure with the aggregated digital fingerprint data structure stored in the object-relational database; and generating the output based at least in part on (i) the hash data structure added to the application-specific distributed ledger, (ii) the aggregated digital fingerprint data structure stored in the object-relational database, and (iii) the document data structure.

Clause 20. A computer program product comprising at least one non-transitory computer readable storage medium having computer executable code portions stored therein, the computer executable code portions comprising program code instructions configured to: receive an application programming interface (API) data structure that comprises a digital fingerprint for digital data associated with a client device event; aggregate the digital fingerprint with one or more other digital fingerprints to generate an aggregated digital fingerprint data structure that maps the digital fingerprint and the one or more other digital fingerprints via a hierarchical tree structure; generate a hash data structure based at least in part on the aggregated digital fingerprint data structure; add the hash data structure to an application-specific distributed ledger based at least in part on a validation rule set that defines a domain-specific data schema for the application-specific distributed ledger; store the aggregated digital fingerprint data structure in an object-relational database; and generate an output associated with the digital fingerprint based at least in part on (i) the hash data structure added to the application-specific distributed ledger and (ii) the aggregated digital fingerprint data structure stored in the object-relational database.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising one or more processors and one or more storage devices storing instructions that are operable, when executed by the one or more processors, to cause the one or more processors to:
receive an application programming interface (API) data structure that comprises a digital fingerprint for digital data associated with a client device event;
aggregate the digital fingerprint with one or more other digital fingerprints to generate an aggregated digital fingerprint data structure that maps the digital fingerprint and the one or more other digital fingerprints via a hierarchical tree structure;
generate a hash data structure based at least in part on the aggregated digital fingerprint data structure;
add the hash data structure to an application-specific distributed ledger based at least in part on a validation rule set that defines a domain-specific data schema for the application-specific distributed ledger;
store the aggregated digital fingerprint data structure in an object-relational database; and
generate an output associated with the digital fingerprint based at least in part on (i) the hash data structure added to the application-specific distributed ledger and (ii) the aggregated digital fingerprint data structure stored in the object-relational database.

2. The apparatus of claim 1, wherein the digital fingerprint comprises a cryptographic hash of the digital data.

3. The apparatus of claim 2, wherein the digital fingerprint further comprises at least one of a timestamp and an entity identifier.

4. The apparatus of claim 1, wherein the hierarchical tree structure comprises a Merkle tree that maps the digital fingerprint and the one or more other digital fingerprints to a cryptographic hash.

5. The apparatus of claim 1, wherein the instructions are further operable to cause the one or more processors to:
based at least in part on the hash data structure being added to the application-specific distributed ledger, transmit at least a portion of the hash data structure to a consensus layer that connects the application-specific distributed ledger to one or more other distributed ledgers.

6. The apparatus of claim 1, wherein the instructions are further operable to cause the one or more processors to:
cause a rendering of a dashboard visualization associated with the digital fingerprint via an electronic interface based at least in part on (i) the hash data structure added to the application-specific distributed ledger and (ii) the aggregated digital fingerprint data structure stored in the object-relational database.

7. The apparatus of claim 6, wherein the instructions are further operable to cause the one or more processors to:
receive a search query via a search API;
retrieve the digital fingerprint from the object-relational database based at least in part on the search query; and
cause the rendering of the dashboard visualization based at least in part on the search query.

8. The apparatus of claim 1, wherein the instructions are further operable to cause the one or more processors to:
receive a document data structure associated with the digital fingerprint;
verify that a first hash of the document data structure matches a second hash of the digital fingerprint;
correlate the document data structure with the aggregated digital fingerprint data structure stored in the object-relational database; and
generate the output based at least in part on (i) the hash data structure added to the application-specific distributed ledger, (ii) the aggregated digital fingerprint data structure stored in the object-relational database, and (iii) the document data structure.

9. The apparatus of claim 1, wherein the digital fingerprint is a first digital fingerprint, the digital data is first digital data, and the instructions are further operable to cause the one or more processors to:
receive a second digital fingerprint for second digital data associated with the client device;
aggregate the first digital fingerprint and the second digital fingerprint to generate the aggregated digital fingerprint data structure;
generate the hash data structure based at least in part on the aggregated digital fingerprint data structure.

10. The apparatus of claim 1, wherein the digital data associated with the digital fingerprint comprises real estate property data associated one or more real estate asset events.

11. The apparatus of claim 10, wherein the output comprises a dashboard visualization that displays a chronological record of digital fingerprints associated with the real estate property data.

12. The apparatus of claim 1, wherein the digital fingerprint is a first digital fingerprint, the digital data comprises a first image associated with a real estate asset, and the instructions are further operable to cause the one or more processors to:
receive a second digital fingerprint for a second image associated with the real estate asset;
aggregate the first digital fingerprint and the second digital fingerprint to generate the aggregated digital fingerprint data structure;
generate the hash data structure based at least in part on the aggregated digital fingerprint data structure.

13. The apparatus of claim 12, wherein the instructions are further operable to cause the one or more processors to:
generate a real estate audit report for the real estate asset based at least in part on the aggregated digital fingerprint data structure stored in the object-relational database; and
cause a rendering or the real estate audit report via a dashboard visualization.

14. The apparatus of claim 1, wherein the digital data comprises artificial intelligence (AI) decision data associated with one or more inputs utilized by an AI model to generate AI model output, and wherein the output comprises an AI decision log that provides an immutable record of the AI decision data.

15. A computer-implemented method, comprising:
receive an application programming interface (API) data structure that comprises a digital fingerprint for digital data associated with a client device event;
aggregating the digital fingerprint with one or more other digital fingerprints to generate an aggregated digital fingerprint data structure that maps the digital fingerprint and the one or more other digital fingerprints via a hierarchical tree structure;
generating a hash data structure based at least in part on the aggregated digital fingerprint data structure;
adding the hash data structure to an application-specific distributed ledger based at least in part on a validation rule set that defines a domain-specific data schema for the application-specific distributed ledger;
storing the aggregated digital fingerprint data structure in an object-relational database; and
generating an output associated with the digital fingerprint based at least in part on (i) the hash data structure added to the application-specific distributed ledger and (ii) the aggregated digital fingerprint data structure stored in the object-relational database.

16. The computer-implemented method of claim 15, further comprising:
based at least in part on the hash data structure being added to the application-specific distributed ledger, transmitting at least a portion of the hash data structure to a consensus layer that connects the application-specific distributed ledger to one or more other distributed ledgers.

17. The computer-implemented method of claim 15, further comprising:
causing a rendering of a dashboard visualization associated with the digital fingerprint via an electronic interface based at least in part on (i) the hash data structure added to the application-specific distributed ledger and (ii) the aggregated digital fingerprint data structure stored in the object-relational database.

18. The computer-implemented method of claim 17, further comprising:
receiving a search query via a search API;
retrieving the digital fingerprint from the object-relational database based at least in part on the search query; and
causing the rendering of the dashboard visualization based at least in part on the search query.

19. The computer-implemented method of claim 15, further comprising:
receiving a document data structure associated with the digital fingerprint;
verifying that a first hash of the document data structure matches a second hash of the digital fingerprint;
correlating the document data structure with the aggregated digital fingerprint data structure stored in the object-relational database; and
generating the output based at least in part on (i) the hash data structure added to the application-specific distributed ledger, (ii) the aggregated digital fingerprint data structure stored in the object-relational database, and (iii) the document data structure.

20. A computer program product comprising at least one non-transitory computer readable storage medium having computer executable code portions stored therein, the computer executable code portions comprising program code instructions configured to:
receive an application programming interface (API) data structure that comprises a digital fingerprint for digital data associated with a client device event;
aggregate the digital fingerprint with one or more other digital fingerprints to generate an aggregated digital fingerprint data structure that maps the digital fingerprint and the one or more other digital fingerprints via a hierarchical tree structure;
generate a hash data structure based at least in part on the aggregated digital fingerprint data structure;
add the hash data structure to an application-specific distributed ledger based at least in part on a validation rule set that defines a domain-specific data schema for the application-specific distributed ledger;
store the aggregated digital fingerprint data structure in an object-relational database; and
generate an output associated with the digital fingerprint based at least in part on (i) the hash data structure added to the application-specific distributed ledger and (ii) the aggregated digital fingerprint data structure stored in the object-relational database.
